(19) United States
(12) Patent Application Publication
(10) Pub. No.: US 2025/0390757 A1
(43) Pub. Date: Dec. 25, 2025

(54) INFORMATION PROCESSING SYSTEM, INFORMATION PROCESSING DEVICE, INFORMATION PROCESSING METHOD, SCHEDULING METHOD, AND SCHEDULING PROGRAM

(71) Applicant: Preferred Networks, Inc., Tokyo (JP)

(72) Inventor: Gentaro WATANABE, Tokyo (JP)

(21) Appl. No.: 19/241,938

(22) Filed: Jun. 18, 2025

(30) Foreign Application Priority Data
Jun. 20, 2024 (JP) 2024-099445

(51) Int. Cl. G06N 3/096

(52) U.S. Cl. CPC G06N 3/096

(57) ABSTRACT

An information processing system includes one or more first processors and one or more second processors that perform a training process of a neural network. The one or more first processors perform forward processing on first and second data, using first parameters, to generate first and second outputs. The one or more second processors perform forward processing based on the first output, using second parameters, to generate a third output; perform forward processing based on the second output, using the second parameters, to generate a fourth output; generate first gradient information of the second parameters based on the third and outputs; perform a first process on the first gradient information; update the second parameters based on a result of the first process; and transmit the updated second parameters to the one or more first processors. The one or more first processors perform a second process, using the updated second parameters.

### CROSS-REFERENCE TO RELATED APPLICATIONS

This patent application is based on and claims priority to Japanese Patent Application No. 2024-099445 filed on Jun. 20, 2024, the entire contents of which are incorporated herein by reference.

### TECHNICAL FIELD

This disclosure relates to an information processing system, an information processing device, an information processing method, a scheduling method, and a scheduling program.

### BACKGROUND

Data parallelism and pipeline parallelism are known as techniques to improve the training speed of neural networks. In general, when a training process is performed by combining data parallelism and pipeline parallelism, a worker corresponding to each pipeline stage performs a ReduceScatter process of gradient information and an Allgather process of weight parameters.

These processes are performed using a network within the workers after the gradient information is calculated in each of the workers. Therefore, in order to improve the training speed, it is desirable to perform scheduling so as to effectively utilize the network bandwidth between the workers.

### RELATED ART DOCUMENT

### Non-Patent Document

[Non-Patent Document 1] Samyyam Rajbhandari, Jeff Rasley, Olatunji Ruwase, Yuxiong He, “ZeRO: Memory Optimizations Toward Training Trillion Parameter Models,” arXiv: 1910.02054 [cs. LG], 4 Oct. 2019, [Search date 2024.3.13]

### SUMMARY

An information processing system according to one aspect of the present disclosure has, for example, the following configuration. That is, an information processing system includes one or more first processors and one or more second processors configured to perform a training process of a neural network. The one or more first processors are configured to perform forward processing on first data by using first parameters of the neural network to generate a first output; and perform forward processing on second data by using the first parameters to generate a second output. The one or more second processors are configured to perform forward processing based on the first output by using second parameters of the neural network to generate a third output; perform forward processing based on the second output by using the second parameters to generate a fourth output; generate first gradient information of the second parameters based on the third output and the fourth output; perform a first process on the first gradient information; update the second parameters based on a result of performing the first process; and transmit the updated second parameters to the one or more first processors. The one or more first processors are further configured to perform a second process by using the updated second parameters received from the one or more second processors.

### BRIEF DESCRIPTION OF THE DRAWINGS

FIG. 1 is a diagram illustrating an example of a system configuration of an information processing system;

FIG. 2 is a diagram illustrating an example of a hardware configuration of an information processing device;

FIG. 3 is a diagram illustrating an example of a functional configuration of the information processing device;

FIG. 4 is a diagram illustrating an example of constraint conditions of scheduling;

FIG. 5A is a first diagram illustrating a specific example of scheduling information;

FIG. 5B is a second diagram illustrating a specific example of the scheduling information;

FIG. 6A is a first diagram illustrating scheduling of a comparative example;

FIG. 6B is a second diagram illustrating scheduling of the comparative example;

FIG. 7 is a diagram for explaining a ReduceScatter process of each of workers in detail;

FIG. 8 is a diagram for explaining an Allgather process of each of the workers in detail;

FIG. 9 is a diagram illustrating an overview of scheduling performed by an information processing device according to a first embodiment;

FIG. 10A is a first diagram illustrating a specific example of scheduling backward weight calculation executed by a worker whose name is “Worker 3”;

FIG. 10B is a first diagram illustrating a specific example of scheduling the ReduceScatter process and the Allgather process;

FIG. 11A is a first diagram illustrating a specific example of scheduling backward weight calculation executed by a worker whose name is “Worker 2”;

FIG. 11B is a second diagram illustrating a specific example of scheduling the ReduceScatter process and the Allgather process;

FIG. 12A is a first diagram illustrating a specific example of scheduling backward weight calculation executed by a worker whose name is “Worker 1”;

FIG. 12B is a third diagram illustrating a specific example of scheduling the ReduceScatter process and the Allgather process;

FIG. 13A is a first diagram illustrating a specific example of scheduling backward weight calculation executed by a worker whose name is “Worker 0”;

FIG. 13B is a fourth diagram illustrating a specific example of scheduling the ReduceScatter process and the Allgather process;

FIG. 14A is a second diagram illustrating a specific example of scheduling backward weight calculation executed by a worker whose name is “Worker 0”;

FIG. 14B is a fifth diagram illustrating a specific example of scheduling the ReduceScatter process and the Allgather process;

FIG. 15A is a second diagram illustrating a specific example of scheduling backward weight calculation executed by a worker whose name is “Worker 1”;

FIG. 15B is a sixth diagram illustrating a specific example of scheduling the ReduceScatter process and the Allgather process;

FIG. 16A is a second diagram illustrating a specific example of scheduling backward weight calculation executed by a worker whose name is “Worker 2”;

FIG. 16B is a seventh diagram illustrating a specific example of scheduling the ReduceScatter process and the Allgather process;

FIG. 17A is a second diagram illustrating a specific example of scheduling backward weight calculation executed by a worker whose name is “Worker 3”; and

FIG. 17B is an eighth diagram illustrating a specific example of scheduling the ReduceScatter process and the Allgather process.

### DETAILED DESCRIPTION

The present disclosure improves the training speed in performing a training process of a model.

Each embodiment will be described below with reference to the attached drawings. Here, in the present specification and the drawings, components having substantially the same functional configuration will be denoted by the same reference numerals, and thus duplicate descriptions will be omitted.

### First Embodiment

### <System Configuration of Information Processing System>

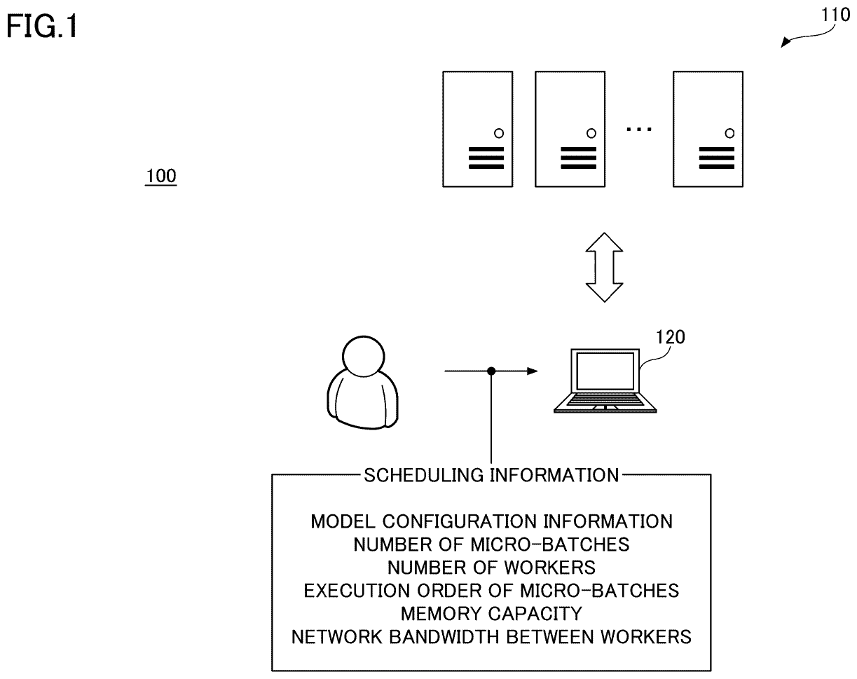

First, a system configuration of an information processing system according to a first embodiment will be described. FIG. 1 is a diagram illustrating an example of the system configuration of the information processing system. As illustrated in FIG. 1, an information processing system 100 according to the first embodiment includes a plurality of server devices (a server device group 110) and an information processing device 120.

The server device group 110 performs a training process on a model to be trained (for example, a neural network; however, it is not limited to the neural network, and a model other than the neural network may be used). The training process performed by the server device group 110 is performed based on a schedule (a training process schedule obtained by combining data parallelism and pipeline parallelism) generated by the information processing device 120.

The information processing device 120 applies data parallelism and pipeline parallelism to a training process for the model to be trained, and generates a schedule for efficiently performing the training process by a plurality of workers. Here, in the present embodiment, the worker refers to a plurality of servers included in the server device group 110. That is, a single worker includes a plurality of servers.

However, the definition of the worker is not limited thereto, and the worker may refer to one or more servers included in the server device group 110. Additionally, a single worker may be one or more servers, or a single worker may be one or more information processing devices. To use a more general expression, the worker may be one or more devices to be specified as a schedule assignment destination.

Alternatively, the worker may refer to a plurality of accelerators included in a single server. That is, a single worker may include a plurality of accelerators. Alternatively, the worker may refer to a single accelerator included in a single server. That is, a single worker may be a single accelerator. Here, in the present embodiment, the accelerator is used as an example, but the accelerator may be read as a graphics processing unit (GPU). Alternatively, the accelerator may be read as a processor. To use a more general expression, the worker may be one component or a group of a plurality of components to be specified as a schedule assignment destination.

Here, in the present embodiment, a process performed by a worker for a micro-batch of training data during the training process includes forward calculation and backward calculation, and a ReduceScatter process and an Allgather process.

That is, the information processing device 120 is configured to:
receive scheduling information as input;
generate a schedule of forward calculation and backward calculation; and
generate a schedule of the ReduceScatter process and the Allgather process.

Specifically, the information processing device 120 receives, for example, as scheduling information, the following information:
configuration information indicating a configuration of a model to be trained;
the number of micro-batches of training data to be used for the training process;
the number of workers to be used for the training process;
the execution order of the micro-batches when the training process is performed;
the memory capacity of each of the workers to be used for the training process; and
the network bandwidth between the workers to be used for the training process.

Additionally, when generating the schedule of forward calculation and backward calculation, the information processing device 120 generates forward calculation identifiers and backward calculation identifiers corresponding in number to the micro-batches included in the scheduling information.

Here, in the information processing system 100 according to the first embodiment, each of the workers executes the backward calculation by dividing it into backward data calculation and backward weight calculation. The backward data calculation refers to, for example, a portion of the backward calculation that calculates a gradient of an activation (data that is not a parameter). The backward weight calculation refers to, for example, a portion of the backward calculation that calculates a gradient of a parameter. However, the method of dividing the backward calculation is not limited thereto. For example, a portion of the backward weight calculation may be regarded as a portion of the backward data calculation, and the method of dividing the backward calculation may be suitably determined.

Thus, the information processing device 120 divides the generated backward calculation identifier into a backward data calculation identifier and a backward weight calculation identifier.

Subsequently, the information processing device 120 arranges the generated forward calculation identifier, backward data calculation identifier, and backward weight calculation identifier at positions indicating execution timing of each of the workers based on the scheduling information. With this, the information processing device 120 can schedule the execution timings of the forward calculation, the backward data calculation, and the backward weight calculation when each of the micro-batches is input. Here, the information processing device 120 schedules the execution timings so that a previously stored constraint condition (a first constraint condition related to the execution order of the forward calculation, the backward data calculation, and the backward weight calculation) is satisfied.

Subsequently, the information processing device 120 schedules, under scheduled execution timings of the forward calculation, the backward data calculation, and the backward weight calculation for each micro-batch input, execution procedures including:
the ReduceScatter process in each of the workers; and
the Allgather process in each of the workers.
   Here, the information processing device 120 schedules the execution procedures so as to satisfy a previously stored constraint condition (a second constraint condition related to the execution order of the ReduceScatter process and the Allgather process).

The information processing device 120 transmits the generated schedule to the server device group 110. With this, the server device group 110 can perform the training process based on the schedule generated by the information processing device 120.

Here, as an example of the training process performed by each of the workers in the server device group 110, for example, when the model to be trained is a neural network (NN), a case where each of the workers performs the training process on a corresponding layer is exemplified as follows:
the worker name=Worker0: layer 1 of the NN;
the worker name=Worker1: layer 2 of the NN; and the like. Alternatively, a case where each of the workers performs the training process on corresponding layers is exemplified as follows:
the worker name=Worker0: layer 1 to layer N of the NN;
the worker name=Worker1: layer N+1 to layer 2N of the NN; and the like.
   That is, the layers of the NN are divided as evenly as possible, and each of the workers performs the training process for the divided layers in order from a layer closest to the input.

However, if the number of layers of the NN is not divisible by the number of workers, there may be a case where the number of layers that are assigned to some workers for performing the training process is less than the number of layers that are assigned to other workers for performing training process. Alternatively, if a special calculation is included in a layer around the input and a layer around the output, there may be a case where the calculation load is unbalanced between the workers.

### <Hardware Configuration of Information Processing Devices>

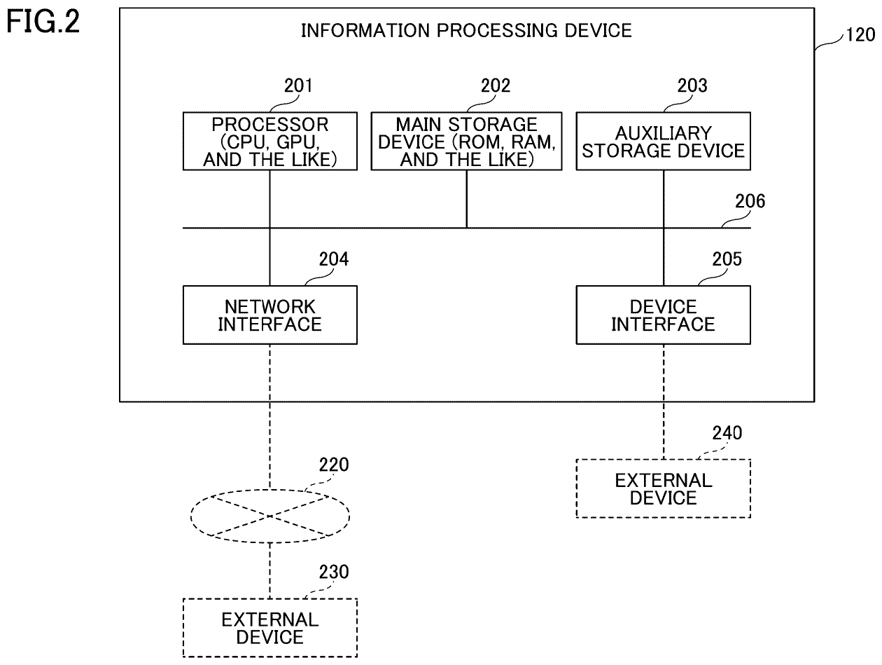

Next, a hardware configuration of the information processing device 120 will be described. FIG. 2 is a diagram illustrating an example of the hardware configuration of the information processing device. The information processing device 120 includes, as components, a processor 201, a main storage device 202 (a memory), an auxiliary storage device 203 (a memory), a network interface 204, and a device interface 205. The information processing device 120 may be realized as a computer in which these components are connected via a bus 206. Here, in the example of FIG. 2, the information processing device 120 is illustrated as including one component each, but the information processing device 120 may include a plurality of the same components.

Various operations of the information processing device 120 may be executed by parallel processing using one or more processors. Additionally, various operations may be distributed to a plurality of operation cores in the processor 201 and executed by parallel processing. Additionally, part or all of the processing, means, and the like of the present disclosure may be executed by an external device 230 (at least one of a processor or a storage device) provided on a cloud that can communicate with the information processing device 120 via the network interface 204.

The processor 201 may be an electronic circuit (a processing circuit, processing circuitry, a CPU, a GPU, an FPGA, an ASIC, and the like). Additionally, the processor 201 may be a semiconductor device or the like including a dedicated processing circuit. Here, the processor 201 is not limited to an electronic circuit using an electronic logic element, but may be realized by an optical circuit using an optical logic element. Additionally, the processor 201 may include an arithmetic function based on quantum computing.

The processor 201 performs various operations based on various data and instructions input from devices of the internal components of the information processing device 120, and outputs calculation results and control signals to the devices. The processor 201 controls each of the components included in the information processing device 120 by executing an operating system (OS), applications, and the like.

Additionally, the processor 201 may refer to one or more electronic circuits arranged on a single chip, or one or more electronic circuits arranged on two or more chips or devices. When a plurality of electronic circuits are used, the electronic circuits may communicate by wire or wirelessly.

The main storage device 202 is a storage device configured to store instructions executed by the processor 201, various data, and the like, and the various data stored in the main storage device 202 are read out by the processor 201. The auxiliary storage device 203 is a storage device other than the main storage device 202. Here, these storage devices indicate any electronic component that can store various data (for example, the first constraint condition and the second constraint condition stored in a constraint condition storage unit 310 described later), and may be semiconductor memories. The semiconductor memory may be either a volatile memory or a non-volatile memory. The storage device for storing various data in the information processing device 120 may be realized by the main storage device 202 or the auxiliary storage device 203, or may be realized by a built-in memory in the processor 201.

Additionally, a plurality of processors 201 may be connected (coupled) to the single main storage device 202, or the single processor 201 may be connected. Alternatively, a plurality of main storage devices 202 may be connected (coupled) to the single processor 201. When the information processing device 120 includes at least one main storage device 202 and a plurality of processors 201 connected (coupled) to the at least one main storage device 202, at least one processor among the plurality of processors 201 may be connected (coupled) to the at least one main storage device 202.

The network interface 204 is an interface for connecting to a communication network 220 by wire or wirelessly.

The device interface 205 is an interface such as a USB that is directly connected to an external device 240.

As an example, the external device 240 may be an input device. In the present embodiment, the input device is, for example, an electronic device, such as a camera, a microphone, various sensors, a keyboard, a mouse, or a touch panel, and provides acquired information to the information processing device 120.

Additionally, the external device 240 may be, for example, an output device. In the present embodiment, the output device may be, for example, a display device such as a liquid crystal display (LCD), a cathode ray tube (CRT), a plasma display panel (PDP), or an organic electro luminescence (EL) panel, or a speaker for outputting sound or the like.

Additionally, the external device 240 may be a storage device (a memory). For example, the external device 240 may be a network storage device, and the external device 240 may be a storage device such as an HDD.

Additionally, the external device 240 may be a device having a function of a part of the components of the information processing device 120. That is, the information processing device 120 may transmit and receive processing results to and from the external device 240.

Here, the hardware configuration of the information processing device 120 has been described, and the hardware configuration of each of the plurality of server devices included in the server device group 110 has not been mentioned. However, at least one server device included in the server device group 110 may have substantially the same hardware configuration as the information processing device 120.

### <Functional Configuration of Information Processing Device>

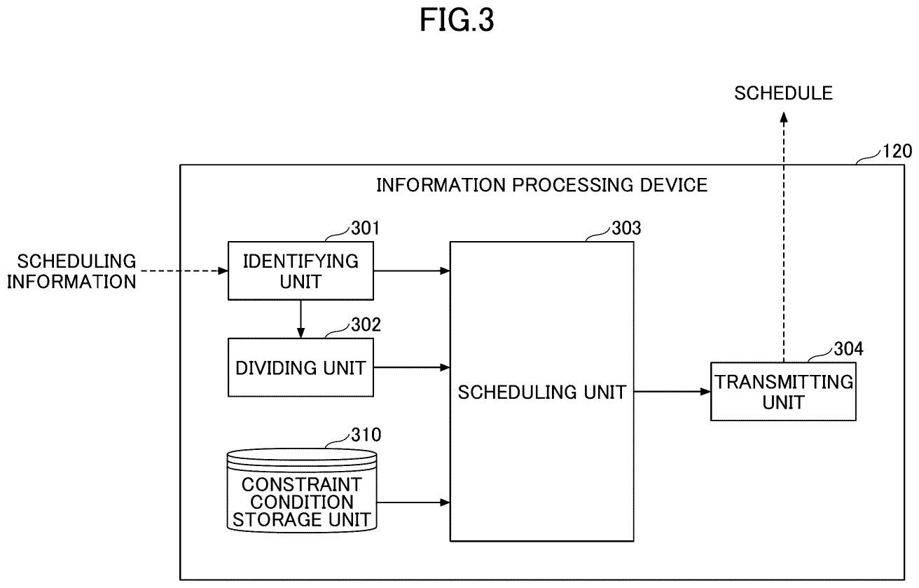

Next, a functional configuration of the information processing device 120 will be described. FIG. 3 is a diagram illustrating an example of the functional configuration of the information processing device. A scheduling program is installed in the information processing device 120, and when the program is executed, the information processing device 120 functions as an identifying unit 301, a dividing unit 302, a scheduling unit 303, and a transmitting unit 304.

The identifying unit 301 receives the scheduling information as input. The scheduling information received by the identifying unit 301 as input has already been described in detail with reference to FIG. 1, and thus the description will be omitted here. The identifying unit 301 notifies the scheduling unit 303 of the scheduling information received as input. Additionally, the identifying unit 301 generates the forward calculation identifiers and the backward calculation identifiers corresponding in number to the micro-batches included in the scheduling information received as input. Additionally, the identifying unit 301 notifies the dividing unit 302 of the generated forward calculation identifiers and backward calculation identifiers.

The dividing unit 302 further divides the backward calculation identifiers, among the forward calculation identifiers and backward calculation identifiers corresponding in number to the micro-batches notified from the identifying unit 301, into backward data calculation identifiers and backward weight calculation identifiers. The dividing unit 302 notifies the scheduling unit 303 of the forward calculation identifiers corresponding in number to the micro-batches and the backward data calculation identifiers and backward weight calculation identifiers corresponding in number to the micro-batches.

The scheduling unit 303 acquires the scheduling information notified from the identifying unit 301, and the forward calculation identifiers, the backward data calculation identifiers, and the backward weight calculation identifiers notified from the dividing unit 302. Additionally, the scheduling unit 303 schedules the execution procedures of the forward calculation, the backward data calculation, and the backward weight calculation in the training process using the micro-batches, by arranging, at positions indicating execution timings of each of the workers based on the scheduling information and the first constraint condition read from the constraint condition storage unit 310, the following identifiers:
the forward calculation identifiers corresponding in number to the micro-batches;
the backward data calculation identifiers corresponding in number to the micro-batches; and
the backward weight calculation identifiers corresponding in number to the micro-batches.

Additionally, the scheduling unit 303 schedules, based on the scheduling information notified from the identifying unit 301 and the second constraint condition read from the constraint condition storage unit 310, the following execution procedures:
the execution procedures of the ReduceScatter process at the workers; and
the execution procedures of the Allgather process at the workers.
   Here, the scheduling unit 303 generates the schedule of the ReduceScatter process and the Allgather process based on the schedule generated for the forward calculation, the backward data calculation, and the backward weight calculation.

The transmitting unit 304 transmits, to the server device group 110, the schedule generated by the scheduling unit 303.

### <Example of Constraint Condition>

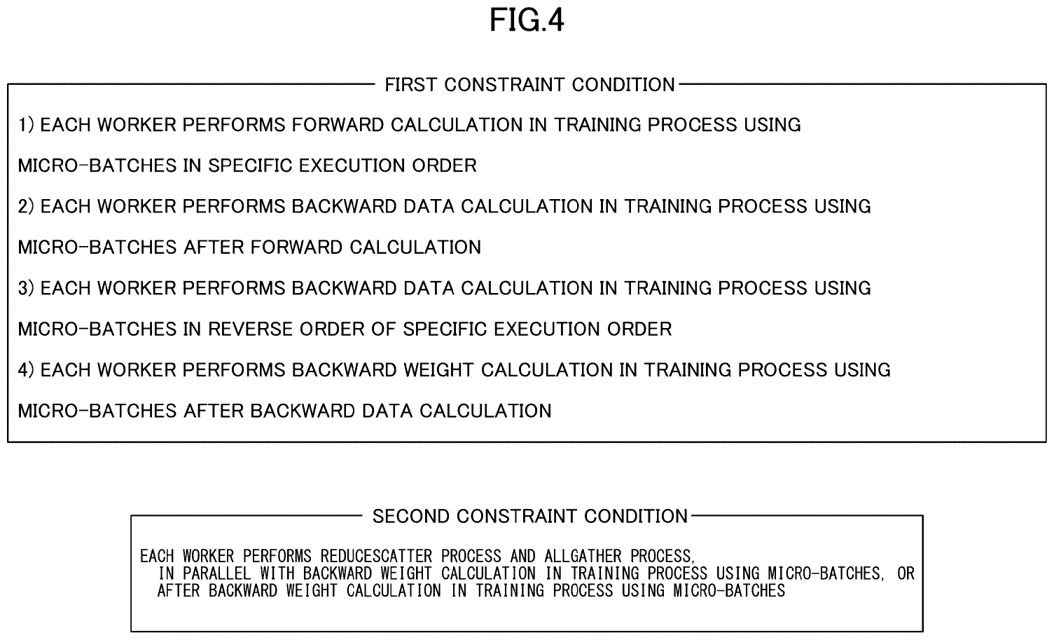

Next, the first and second constraint conditions stored in the constraint condition storage unit 310 will be described in detail. FIG. 4 is a diagram illustrating an example of the constraint conditions.

When scheduling the execution procedures of the forward calculation, the backward data calculation, and the backward weight calculation of the micro-batches, the information processing device 120 schedules the execution procedures so as to satisfy the first constraint condition. As illustrated in FIG. 4, the first constraint condition is as follows.

1) The forward calculations in the training process using the micro-batches are executed in a specific execution order among the workers.
2) Each of the workers executes the backward data calculations in the training process using the micro-batches after the forward calculations in the training process using the micro-batches.
3) The backward data calculations in the training process using the micro-batches are executed in an order opposite to the above specific execution order among the workers.
4) Each of the workers executes the backward weight calculations in the training process using the micro-batches after the backward data calculations in the training process using the micro-batches.

In the information processing device 120, the scheduling unit 303 searches for an arrangement in which the training time is minimum, for example, while arranging the calculation identifiers notified from the dividing unit 302 at the positions indicating the execution timings of each of the workers so as to satisfy the first constraint condition. Here, the scheduling unit 303 may search for an arrangement in which the training time is minimum by solving an optimization problem.

When scheduling the execution procedures of the ReduceScatter process and the Allgather process in the training process using the micro-batches at each of the workers, the information processing device 120 schedules the execution procedures so as to satisfy the second constraint condition. As illustrated in FIG. 4, the second constraint condition is “Each of the workers performs the ReduceScatter process and the Allgather process in parallel with or after the backward weight calculation in training process using the micro-batches”. Here, the term “parallel” refers to a state in which at least some of a plurality of processes overlap in time during execution. Additionally, the ReduceScatter process refers to a process of reducing information (for example, gradient information) by group communication, and the Allgather process refers to a process of gathering parameters (for example, weight parameters) by group communication in parallel. Here, the gradient information refers to information necessary to update the weight parameters, and includes:
information before the ReduceScatter process (gradient information of the weight parameters calculated using a part of the input data); and
information after the ReduceScatter process (information obtained by converting the gradient information with a suitable method, typically compressing the gradient information).

In the information processing device 120, the scheduling unit 303 schedules the execution procedures of the ReduceScatter process and the Allgather process of each of the micro-batches so as to improve the training speed while satisfying the second constraint condition. Specifically, in the first embodiment, the scheduling unit 303 schedules the execution procedures so that the network bandwidth between the workers is effectively utilized, thereby improving the training speed when the training process is performed by each of the workers.

### <Specific Example of Scheduling>

Next, a specific example of the scheduling performed by the scheduling unit 303 will be described.

### (1) Scheduling Information

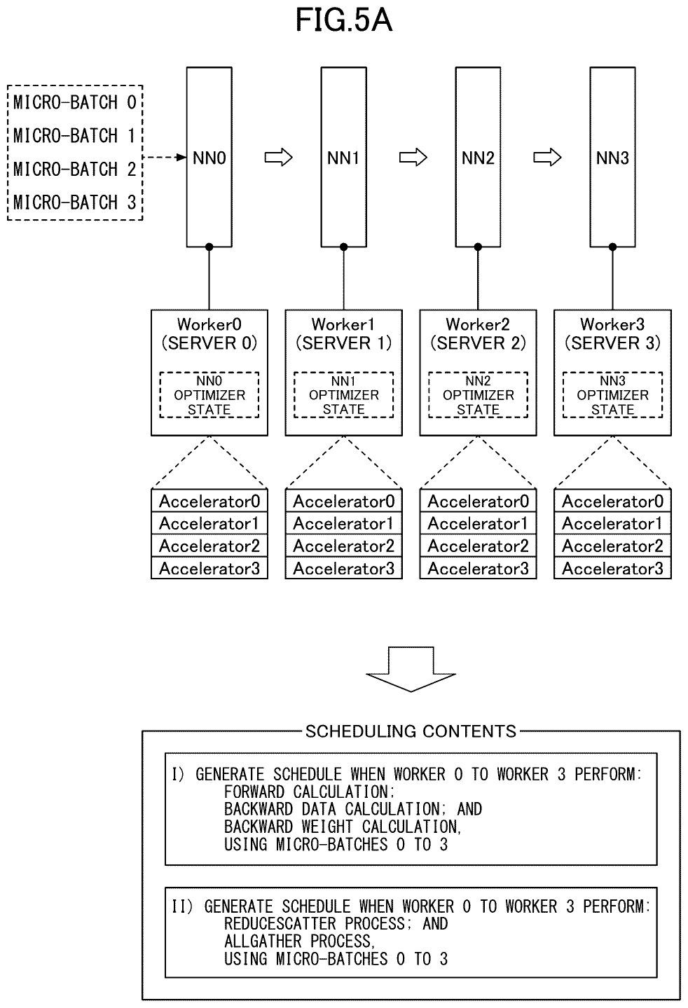

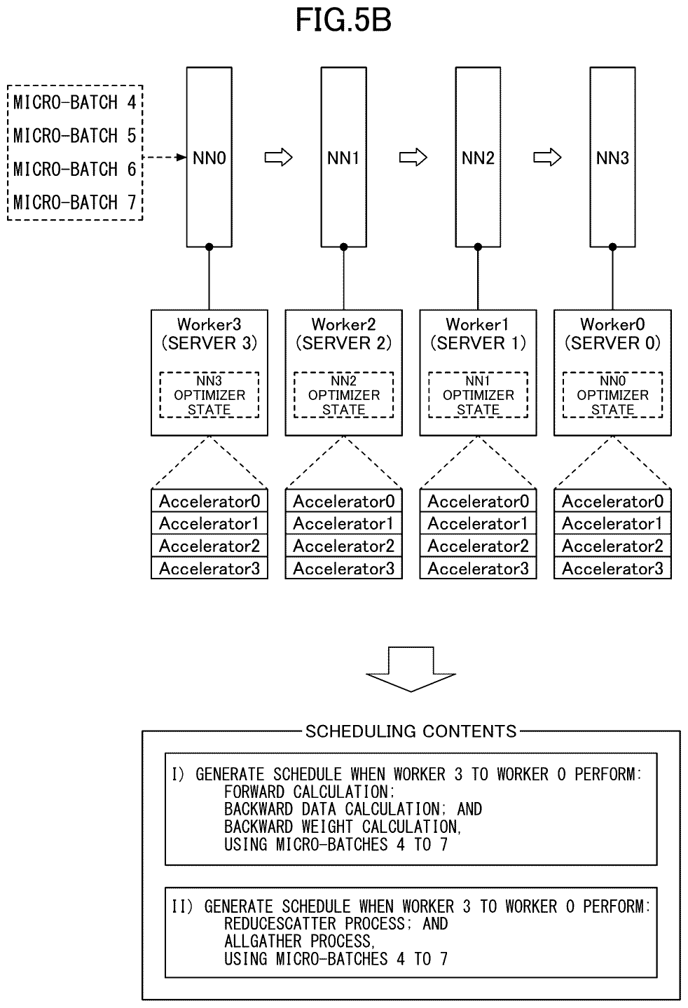

First, a specific example of the scheduling information input when the scheduling unit 303 performs the scheduling will be described. FIGS. 5A and 5B are first and second diagrams illustrating specific examples of the scheduling information.

As illustrated in FIGS. 5A and 5B, a neural network as a model to be trained includes four layers “NN0” to “NN3”. Among them, FIG. 5A illustrates a case where Micro-batches 0 to 3 are input when the training process is performed on the model to be trained. FIG. 5B illustrates a case where Micro-batches 4 to 7 are input when the training process is performed on the model to be trained.

Additionally, the example of FIG. 5A indicates a case where a worker whose name is “Worker 0” is assigned to a training process for the layer “NN0” and a worker whose name is “Worker 1” is assigned to a training process for the layer “NN1”. Additionally, the example of FIG. 5A indicates a case where a worker whose name is “Worker 2” is assigned to a training process for the layer “NN2” and a worker whose name is “Worker 3” is assigned to a training process for the layer “NN3”.

In the example of FIG. 5A, each of the workers is a single server device, and each of the server devices includes four accelerators.

Similarly, the example of FIG. 5B indicates a case where the worker whose name is “Worker 3” is assigned to a training process for the layer “NN0” and the worker whose name is “Worker 2” is assigned to a training process for the layer “NN1”. Additionally, the example of FIG. 5B indicates a case where the worker whose name is “Worker 1” is assigned to a training process for the layer “NN2” and the worker whose name is “Worker 0” is assigned to a training process for the layer “NN3”.

In the example of FIG. 5B, the workers are the same as the workers illustrated in the example of FIG. 5A (each of the workers is a single server device and each of the server devices includes four accelerators), but the assignment destination is different from that of each of the workers illustrated in the example of FIG. 5A.

Based on the scheduling information illustrated in FIGS. 5A and 5B, in a specific example ((5) and (6)) to be described later, the specific examples describe a case where the scheduling unit 303 performs, under the combination of data parallelism and pipeline parallelism, the following scheduling:
scheduling for assigning the forward calculations, the backward data calculations, and the backward weight calculations in the training process using the micro-batches (Micro-batches 0 to 3) to the workers whose names are “Worker 0” to “Worker 3”;
scheduling for assigning the ReduceScatter processes and the Allgather processes in the training process using the micro-batches (Micro-batches 0 to 3) to the workers whose names are “Worker 0” to “Worker 3”;
scheduling for assigning the forward calculations, the backward data calculations, and the backward weight calculations in the training process using the micro-batches (Micro-batches 4 to 7) to the workers whose names are “Worker 3” to “Worker 0”; and
scheduling for assigning the ReduceScatter processes and the Allgather processes in the training process using the micro-batches (Micro-batches 4 to 7) to the workers whose names are “Worker 3” to “Worker 0”.

However, among them, the scheduling of the forward calculations, the backward data calculations, and the backward weight calculations in the training process using the micro-batches (Micro-batches 0 to 3 and 4 to 7) indicates the generated schedule. That is, the description of the process of arranging the calculation identifiers during scheduling is omitted.

### (2) Scheduling of Comparative Example

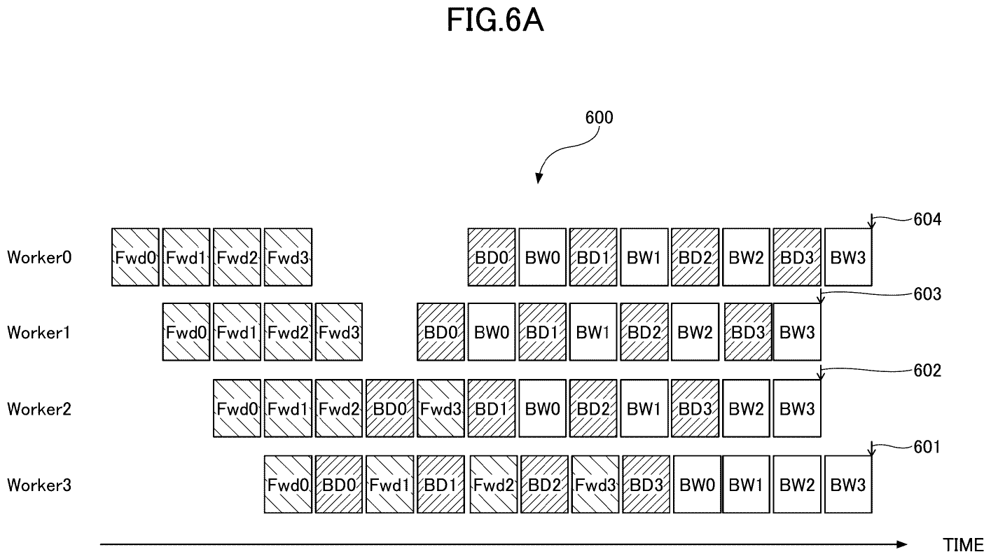

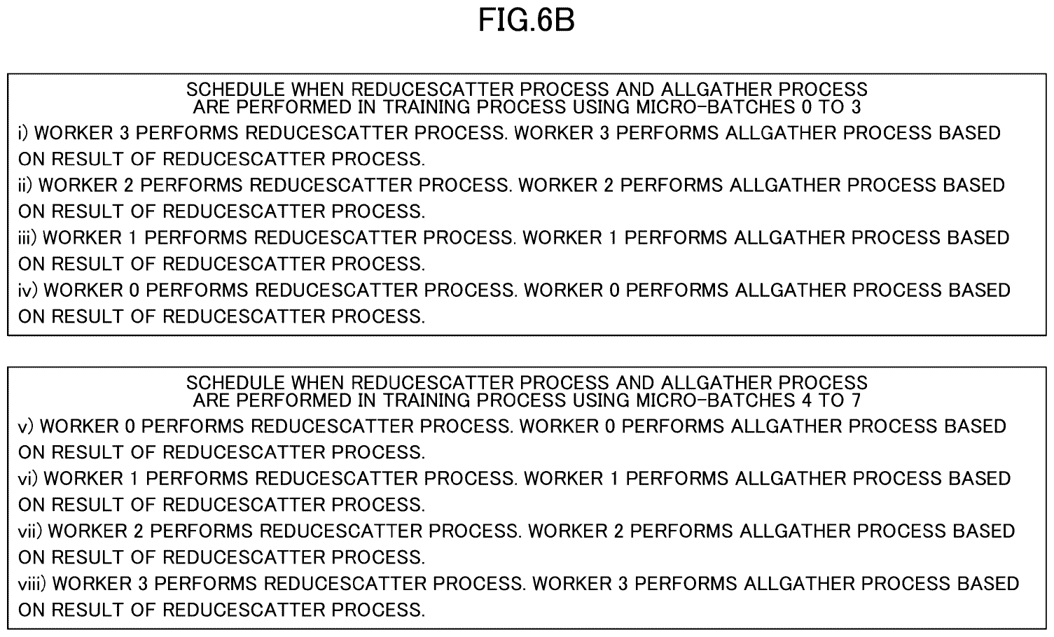

Next, based on the scheduling information illustrated in FIG. 5A, a schedule generated by a scheduling unit of a comparative example will be described. The scheduling unit of the comparative example is a generic name for a scheduling unit for clarifying a difference between a schedule generated by the scheduling unit 303 of the information processing device 120 according to the first embodiment and a general schedule. FIG. 6A is a first diagram illustrating the scheduling of the comparative example.

In FIG. 6A, reference numeral 600 denotes an example of a schedule generated by the scheduling unit of the comparative example for the forward calculations, the backward data calculations, and the backward weight calculations in the training process using the micro-batches (Micro-batches 0 to 3). Here, the scheduling unit of the comparative example generates the schedule denoted by reference numeral 600 by performing scheduling so as to satisfy the first constraint condition indicated in FIG. 4 based on the scheduling information indicated in FIG. 5A.

In the schedule denoted by reference numeral 600, the horizontal axis indicates the time, and the vertical axis indicates the worker name of each of the workers. Each of the calculation identifiers is arranged in an area where the time intersects the worker name of the worker.

Among the calculation identifiers arranged in the schedule denoted by reference numeral 600,
Fwd0 to Fwd3 respectively represent a forward calculation identifier in the training process using the micro-batch 0 to a forward calculation identifier in the training process using the micro-batch 3,
BD0 to BD3 respectively represent a backward data calculation identifier in the training process using the micro-batch 0 to a backward data calculation identifier in the training process using the micro-batch 3, and
BW0 to BW3 respectively represent a backward weight calculation identifier in the training process using the micro-batch 0 to a backward weight calculation identifier in the training process using the micro-batch 3.
   Here, the length of each of the calculation identifiers in the time axis direction represents the time required for the calculation. Additionally, an area in the time axis direction where the calculation identifier is not arranged represents the time when the worker is not performing the process.

Additionally, in FIG. 6A, reference numeral 604 denotes the start timing when the worker whose name is “Worker 0” performs the ReduceScatter process and the Allgather process in the training process using Micro-batches 0 to 3. The ReduceScatter process and the Allgather process can be performed after the last backward weight calculation (“BW3”) is completed. Therefore, the scheduling unit of the comparative example performs scheduling such that the worker whose name is “Worker 0” starts the ReduceScatter process and the Allgather process at the timing denoted by reference numeral 604.

Similarly, in FIG. 6A, reference numeral 603 denotes the start timing when the worker whose name is “Worker 1” performs the ReduceScatter process and the Allgather process in the training process using Micro-batches 0 to 3. The ReduceScatter process and the Allgather process can be performed after the last backward weight calculation (“BW3”) is completed. Therefore, the scheduling unit of the comparative example performs scheduling such that the worker whose name is “Worker 1” starts the ReduceScatter process and the Allgather process at the timing denoted by reference numeral 603.

Similarly, in FIG. 6A, reference numeral 602 denotes the start timing when the worker whose name is “Worker 2” performs the ReduceScatter process and the Allgather process in the training process using Micro-batches 0 to 3. The ReduceScatter process and the Allgather process can be performed after the last backward weight calculation (“BW3”) is completed. Therefore, the scheduling unit of the comparison example performs scheduling such that the worker whose name is “Worker 2” starts the ReduceScatter process and the Allgather process at the timing denoted by reference numeral 602.

Similarly, in FIG. 6A, reference numeral 601 denotes the start timing when the worker whose name is “Worker 3” performs the ReduceScatter process and the Allgather process in the training process using Micro-batches 0 to 3. The ReduceScatter process and the Allgather process can be performed after the last backward weight calculation (“BW3”) is completed. Therefore, the scheduling unit of the comparison example performs scheduling such that the worker whose name is “Worker 3” starts the ReduceScatter process and the Allgather process at the timing denoted by reference numeral 601.

FIG. 6B is a second diagram illustrating the scheduling of the comparison example. The scheduling unit of the comparison example performs scheduling such that
each of the workers performs the ReduceScatter process on the gradient information calculated in the training process using the micro-batches (Micro-batches 0 to 3 and 4 to 7) (reduces elements of the gradient information held by the ranks (the accelerators)), and
each of the workers updates weight parameters based on the information acquired by performing the ReduceScatter process, and performs the Allgather process on the updated weight parameters.
   Here, the updated weight parameter includes, in addition to the updated weight parameter itself, a compressed version of the updated weight parameter, and a converted version of the updated weight parameter that is converted by any suitable method (the updated weight parameter can be restored or acquired).

Specifically, as illustrated in FIG. 6B, the scheduling unit of the comparative example generates the following schedule as a schedule for performing the ReduceScatter process and the Allgather process in the training process using Micro-batches 0 to 3.

i) The worker whose name is “Worker 3” performs the ReduceScatter process on the gradient information. Additionally, the worker whose name is “Worker 3” updates the weight parameters based on information acquired by performing the ReduceScatter process, and performs the Allgather process on the updated weight parameters.
ii) The worker whose name is “Worker 2” performs the ReduceScatter process on the gradient information. The worker whose name is “Worker 2” updates the weight parameters based on information acquired by performing the ReduceScatter process, and performs the Allgather process on the updated weight parameters.
iii) The worker whose name is “Worker 1” performs the ReduceScatter process on the gradient information. The worker whose name is “Worker 1” updates the weight parameters based on information acquired by performing the ReduceScatter process, and performs the Allgather process on the updated weight parameters.
iv) The worker whose name is “Worker 0” performs the ReduceScatter process on the gradient information. The worker whose name is “Worker 0” updates the weight parameters based on information acquired by performing the ReduceScatter process, and performs the Allgather process on the updated weight parameters.

Similarly, as illustrated in FIG. 6B, the scheduling unit of the comparative example generates the following schedule for performing the ReduceScatter process and the Allgather process in the training process using Micro-batches 4 to 7.

v) The worker whose name is “Worker 0” performs the ReduceScatter process on the gradient information. The worker whose name is “Worker 0” updates the weight parameters based on information acquired by performing the ReduceScatter process, and performs the Allgather process on the updated weight parameters.
vi) The worker whose name is “Worker 1” performs the ReduceScatter process on the gradient information. The worker whose name is “Worker 1” updates the weight parameters based on information acquired by performing the ReduceScatter process, and performs the Allgather process on the updated weight parameters.
vii) The worker whose name is “Worker 2” performs the ReduceScatter process on the gradient information. The worker whose name is “Worker 2” updates the weight parameters based on information obtained by performing the ReduceScatter process, and performs the Allgather process on the updated weight parameters.
viii) The worker whose name is “Worker 3” performs the ReduceScatter process on the gradient information. The worker whose name is “Worker 3” updates the weight parameters based on information obtained by performing the ReduceScatter process, and performs the Allgather process on the updated weight parameters.

Here, the processes described in i) to iv) are performed in parallel, and the execution order is not indicated. Similarly, the processes described in v) to viii) are performed in parallel, and the execution order is not indicated.

The schedule generated in such a way is transmitted to the server device group 110 and distributed to each of the workers as described above. The distribution method to each of the workers is suitably selected, for example, when the schedule is generated in a server device different from the workers, the server device distributes the schedule to the workers. Additionally, when the schedule is generated in one worker among the workers, the one worker distributes the schedule to the other workers. Additionally, when the same schedule is generated in the workers, each of the workers extracts a corresponding part of the schedule.

### (3) ReduceScatter Process and Allgather Process of Comparative Example

Next, the ReduceScatter process and the Allgather process scheduled by the scheduling unit 303 of the comparative example will be described in detail.

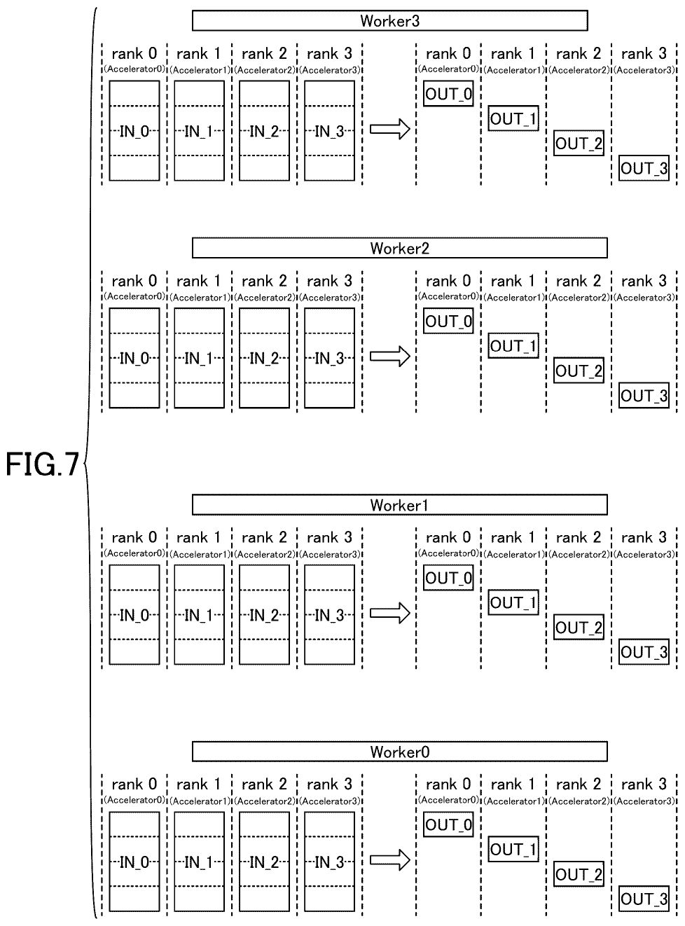

FIG. 7 is a diagram for explaining the ReduceScatter process of each of the workers in detail. As described above, the worker whose name is “Worker 3” performs the ReduceScatter process at the start timing of reference numeral 601.

Specifically, before the start timing of reference numeral 601, the accelerators (Accelerators 0 to 3) included in the worker whose name is “Worker 3” execute, in the training process using the micro-batches (Micro-batches 0 to 3), the following calculations:
the backward data calculation; and
the backward weight calculation.
   With this, as illustrated in FIG. 7, the accelerators (Accelerators 0 to 3) included in the worker whose name is “Worker 3” acquire gradient information (IN_0 to IN_3). Here, each of the gradient information (IN_0 to IN_3) includes elements of the gradient information corresponding in number to the accelerators (four in the example illustrated in FIG. 7). The dotted lines included in each of IN_0 to IN_3 in FIG. 7 indicate that each of IN_0 to IN_3 includes four elements of the gradient information. Then, at the start timing of reference numeral 601, the worker whose name is “Worker 3” reduces the gradient information acquired by each of the accelerators between the accelerators, and one of the accelerators holds the reduced result. For example, the worker whose name is “Worker 3” reduces the first element of the gradient information among the four elements of the gradient information included in each of IN_0 to IN_3 between the accelerators, and Accelerator 0 holds the reduced result (the second to fourth elements are processed in substantially the same manner). With this, the accelerators included in the worker whose name is “Worker 3” acquire the reduced results (OUT_0 to OUT_3).

Similarly, the worker whose name is “Worker 2” performs the ReduceScatter process at the start timing of reference numeral 602.

Specifically, before the start timing of reference numeral 602, the accelerators (Accelerators 0 to 3) of the worker whose name is “Worker 2” execute, in the training process using the micro-batches (Micro-batches 0 to 3), the following calculations:
the backward data calculation; and
the backward weight calculation.
   With this, as illustrated in FIG. 7, the accelerators (Accelerators 0 to 3) included in the worker whose name is “Worker 2” acquire the gradient information (IN_0 to IN_3). Here, each of the gradient information (IN_0 to IN_3) includes elements of the gradient information corresponding in number to the accelerators (four in the example of FIG. 7). The dotted lines included in each of IN_0 to IN_3 in FIG. 7 indicate that each of IN_0 to IN_3 includes four elements of the gradient information. Then, at the start timing of reference numeral 602, the worker whose name is “Worker 2” reduces the gradient information acquired by each of the accelerators between the accelerators, and one of the accelerators holds the reduced result. For example, the worker whose name is “Worker 2” reduces the first element of the gradient information among the four elements of the gradient information included in each of IN_0 to IN_3 between the accelerators, and Accelerator 0 holds the reduced result (the second to fourth elements are processed in substantially the same manner). With this, the accelerators of the worker whose name is “Worker 2” acquire the reduced results (OUT_0 to OUT_3).

Similarly, the worker whose name is “Worker 1” performs the ReduceScatter process at the start timing of reference numeral 603.

Specifically, before the start timing of reference numeral 603, the accelerators (Accelerators 0 to 3) of the worker whose name is “Worker 1” execute, in the training process using the micro-batches (Micro-batches 0 to 3), the following calculations:
the backward data calculation; and
the backward weight calculation.
   With this, as illustrated in FIG. 7, the accelerators (Accelerators 0 to 3) included in the worker whose name is “Worker 1” acquire the gradient information (IN_0 to IN_3). Here, each of the gradient information (IN_0 to IN_3) includes elements of the gradient information corresponding in number to the accelerators (four in the example of FIG. 7). The dotted lines included in each of IN_0 to IN_3 in FIG. 7 indicate that each of IN_0 to IN_3 includes four elements of the gradient information. Then, at the start timing of reference numeral 603, the worker whose name is “Worker 1” reduces the gradient information acquired by each of the accelerators between the accelerators, and one of the accelerators holds the reduced result. For example, the worker whose name is “Worker 1” reduces the first element of the gradient information among the four elements of the gradient information included in each of IN_0 to IN_3 between the accelerators, and Accelerator 0 holds the reduced result (the second to fourth elements are processed in substantially the same manner). With this, the accelerators included in the worker whose name is “Worker 1” acquire the reduced results (OUT_0 to OUT_3).

Similarly, the worker whose name is “Worker 0” performs the ReduceScatter process at the start timing of reference numeral 604.

Specifically, before the start timing of reference numeral 604, the accelerators (Accelerators 0 to 3) included in the worker whose name is “Worker 0” execute, in the training process using the micro-batches (Micro-batches 0 to 3), the following calculations:
the backward data calculation; and
the backward weight calculation.
   With this, as illustrated in FIG. 7, the accelerators (Accelerators 0 to 3) included in the worker whose name is “Worker 0” acquire gradient information (IN_0 to IN_3). Each of the gradient information (IN_0 to IN_3) includes elements of the gradient information corresponding in number to the accelerators (four in the example of FIG. 7). The dotted lines included in each of IN_0 to IN_3 in FIG. 7 indicate that each of IN_0 to IN_3 includes four elements of the gradient information. Then, at the start timing of reference numeral 604, the worker whose name is “Worker 0” reduces the gradient information acquired by each of the accelerators between the accelerators, and one of the accelerators holds the reduced result. For example, the worker whose name is “Worker 0” reduces the first element of the gradient information among the four elements of the gradient information included in each of IN_0 to IN_3 between the accelerators, and Accelerator 0 holds the reduced result (the second to fourth elements are processed in substantially the same manner). With this, the accelerators included in the worker whose name is “Worker 0” acquire the reduced results (OUT_0 to OUT_3).

Here, in the example illustrated in FIG. 7, the case where the ReduceScatter process is performed on the gradient information calculated in the training process using Micro-batches 0 to 3 has been described. However, the same applies to the case where the ReduceScatter process is performed on the gradient information calculated in the training process using Micro-batches 4 to 7. Therefore, the description is omitted here.

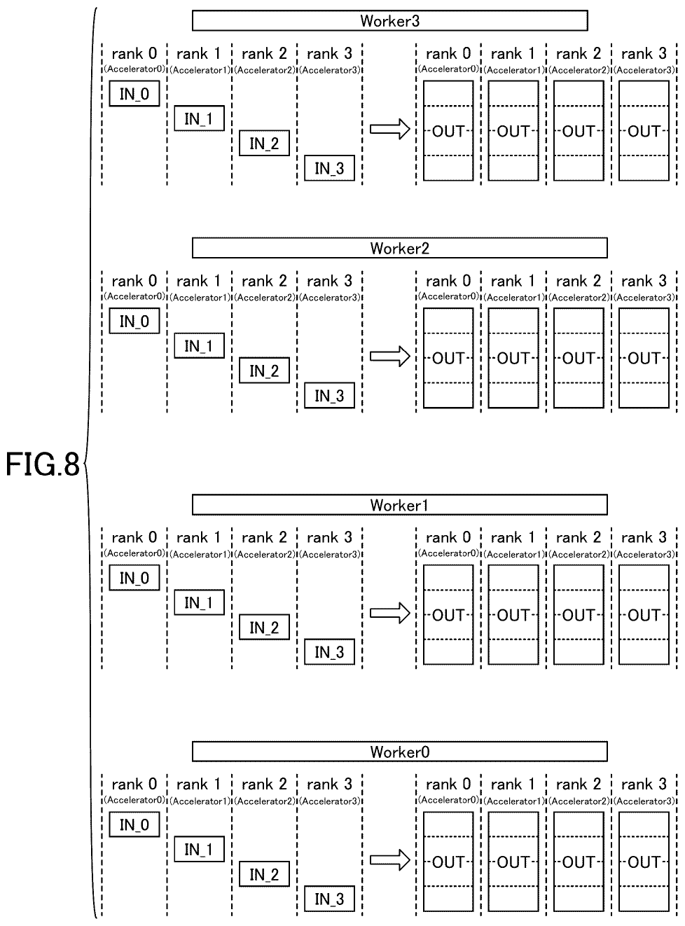

FIG. 8 is a diagram for explaining the Allgather process of each of the workers in detail. When the ReduceScatter process of the worker whose name is “Worker 3” is completed, the accelerators (Accelerators 0 to 3) of the worker whose name is “Worker 3”:
update an optimizer state (for example, 32-bit) of NN3 of the worker whose name is “Worker 3” using the gradient information on which the ReduceScatter process has been performed; and
convert the weight parameter included in the updated optimizer state (for example, convert a 32-bit weight parameter to a 16-bit weight parameter).

After that, the worker whose name is “Worker 3” performs the Allgather process as illustrated in FIG. 8. Here, the optimizer state includes various values necessary for optimization in addition to the weight parameter, but after conversion (for example, to 16-bit), the Allgather process is performed only on the weight parameter.

Specifically, the worker whose name is “Worker 3” gathers the weight parameters (IN_0 to IN_3). Additionally, the worker whose name is “Worker 3” distributes the gathered weight parameters to the accelerators (Accelerators 0 to 3) of the worker whose name is “Worker3”.

Similarly, when the ReduceScatter process of the worker whose name is “Worker 2” is completed, the accelerators (Accelerators 0 to 3) of the worker whose name is “Worker 2”:
update an optimizer state (for example, 32-bit) of NN2 of the worker whose name is “Worker 2” using the gradient information on which the ReduceScatter process has been performed; and
convert the weight parameter included in the updated optimizer state (for example, convert a 32-bit weight parameter to a 16-bit weight parameter).

After that, the worker whose name is “Worker 2” performs the Allgather process as illustrated in FIG. 8. Here, the optimizer state includes various values necessary for optimization in addition to the weight parameter, but after conversion (for example, to 16-bit), the Allgather process is performed only on the weight parameter.

Specifically, the worker whose name is “Worker 2” gathers the weight parameters (IN_0 to IN_3). The worker whose name is “Worker 2” distributes the gathered weight parameters to the accelerators (Accelerators 0 to 3) of the worker whose name is “Worker2”.

Similarly, when the ReduceScatter process of the worker whose name is “Worker 1” is completed, the accelerators (Accelerators 0 to 3) of the worker whose name is “Worker 1”:
update an optimizer state (for example, 32-bit) of NN1 of the worker whose name is “Worker 1” using the gradient information on which the ReduceScatter process has been performed; and
convert the weight parameter included in the updated optimizer state (for example, convert a 32-bit weight parameter to a 16-bit weight parameter).

After that, the worker whose name is “Worker 1” performs the Allgather process as illustrated in FIG. 8. Here, the optimizer state includes various values necessary for optimization in addition to the weight parameter, but after conversion (for example, to 16-bit), the Allgather process is performed only on the weight parameter.

Specifically, the worker whose name is “Worker 1” gathers the weight parameters (IN_0 to IN_3). The worker whose name is “Worker 1” distributes the gathered weight parameters to the accelerators (Accelerators 0 to 3) of the worker whose name is “Worker 1”.

Similarly, when the ReduceScatter process of the worker whose name is “Worker 0” is completed, the accelerators (Accelerators 0 to 3) of the worker whose name is “Worker 0”:
update an optimizer state (for example, 32-bit) of NN0 of the worker whose name is “Worker 0” using the gradient information on which the ReduceScatter process has been performed; and
convert the weight parameter included in the updated optimizer state (for example, convert a 32-bit weight parameter to a 16-bit weight parameter).

After that, the worker whose name is “Worker 0” performs the Allgather process as illustrated in FIG. 8. Here, the optimizer state includes various values necessary for optimization in addition to the weight parameter, but after conversion (for example, to 16-bit), the Allgather process is performed only on the weight parameters.

Specifically, the worker whose name is “Worker 0” gathers the weight parameters (IN_0 to IN_3). The worker whose name is “Worker 0” distributes the gathered weight parameters to the accelerators (Accelerators 0 to 3) included in the worker whose name is “Worker 0”.

As is clear from the explanation of FIGS. 7 and 8, when performing the ReduceScatter process and the Allgather process, communication (reduction, gather, distribution) occurs between the accelerators in the workers.

With respect to the above, the start timing of the ReduceScatter process and the start timing of the Allgather process differ among the workers. Therefore, the communication timings between the accelerators that occur when performing the ReduceScatter process and the Allgather process also differ among the workers.

For example, when the worker whose name is “Worker 2” starts the ReduceScatter process of the gradient information, the worker whose name is “Worker 0” has not yet started the ReduceScatter process of the gradient information.

That is, this means that the worker whose name is “Worker 0” is in a state where the network bandwidth usage rate in the worker is still low when the worker whose name is “Worker 2” starts the ReduceScatter process of the gradient information.

Focusing on this point, in the information processing device 120 according to the first embodiment, the scheduling unit 303 generates a schedule for improving the training speed by effectively utilizing the network bandwidth between the workers. An overview of the scheduling performed by the scheduling unit 303 and a specific example of the generated schedule will be described below.

### (4) Overview of Scheduling Performed by Scheduling Unit 303

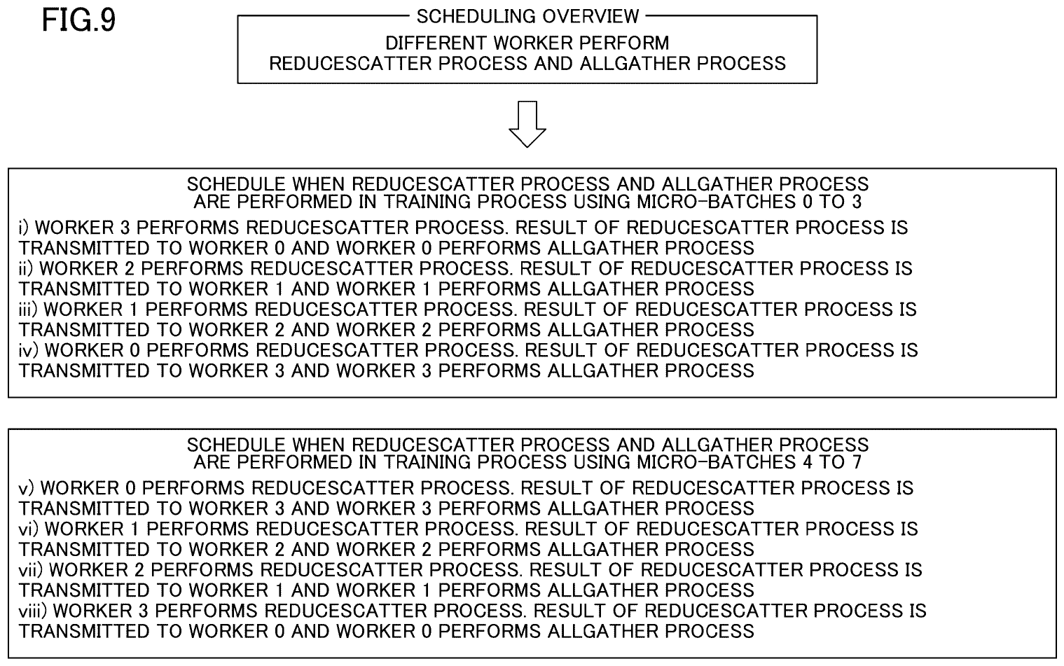

First, the overview of the scheduling performed by the scheduling unit 303 will be described. FIG. 9 is a diagram illustrating the overview of the scheduling. As illustrated in FIG. 9, the scheduling unit 303 performs the scheduling such that
a first worker performs the ReduceScatter process on the gradient information,
information acquired by the first worker performing the ReduceScatter process is transmitted to a second worker,
the second worker receives the information acquired by performing the ReduceScatter process from the first worker, and
the second worker performs the Allgather process on the weight parameters.
   Here, the first worker refers to a worker scheduled to execute the backward data calculation in the training process using the micro-batches (Micro-batches 0 to 3 and 4 to 7) earlier than the second worker.

Specifically, as illustrated in FIG. 9, the scheduling unit 303 generates the following schedule as a schedule for performing the ReduceScatter process and the Allgather process in the training process using Micro-batches 0 to 3.

i) The worker whose name is “Worker 3” performs the ReduceScatter process on the gradient information. Additionally, the worker whose name is “Worker 3” updates the weight parameters based on the information acquired by performing the ReduceScatter process and transmits them to the worker whose name is “Worker 0”. The worker whose name is “Worker 0” performs the Allgather process on the updated weight parameters.
ii) The worker whose name is “Worker 2” performs the ReduceScatter process on the gradient information. Additionally, the worker whose name is “Worker 2” updates the weight parameters based on the information obtained by performing the ReduceScatter process, and transmits them to the worker whose name is “Worker 1”. The worker whose name is “Worker 1” performs the Allgather process on the updated weight parameters.
iii) The worker whose name is “Worker 1” performs the ReduceScatter process on the gradient information. Additionally, the worker whose name is “Worker 1” updates the weight parameters based on the information obtained by performing the ReduceScatter process, and transmits them to the worker whose name is “Worker 2”. The worker whose name is “Worker 2” performs the Allgather process on the updated weight parameters.
iv) The worker whose name is “Worker 0” performs the ReduceScatter process on the gradient information. Additionally, the worker whose name is “Worker 0” updates the weight parameters based on the information obtained by performing the ReduceScatter process, and transmits them to the worker whose name is “Worker 3”. The worker whose name is “Worker 3” performs the Allgather process on the updated weight parameters.

Similarly, as illustrated in FIG. 9, the scheduling unit 303 generates the following schedule as a schedule for performing the ReduceScatter process and the Allgather process in the training process using Micro-batches 4 to 7.

v) The worker whose name is “Worker 0” performs the ReduceScatter process on the gradient information. Additionally, the worker whose name is “Worker 0” transmits the information acquired by performing the ReduceScatter process to the worker whose name is “Worker 3”. The worker whose name is “Worker 3” updates the weight parameters based on the transmitted information, and performs the Allgather process on the updated weight parameters.
vi) The worker whose name is “Worker 1” performs the ReduceScatter process on the gradient information. Additionally, the worker whose name is “Worker 1” transmits the information acquired by performing the ReduceScatter process to the worker whose name is “Worker 2”. The worker whose name is “Worker 2” updates the weight parameters based on the transmitted information, and performs the Allgather process on the updated weight parameters.
vii) The worker whose name is “Worker 2” performs the ReduceScatter process on the gradient information. Additionally, the worker whose name is “Worker 2” transmits the information acquired by performing the ReduceScatter process to the worker whose name is “Worker 1”. The worker whose name is “Worker 1” updates the weight parameters based on the transmitted information, and performs the Allgather process on the updated weight parameters.
viii) The worker whose name is “Worker 3” performs the ReduceScatter process on the gradient information. Additionally, the worker whose name is “Worker 3” transmits the information acquired by performing the ReduceScatter process to the worker whose name is “Worker 0”. The worker whose name is “Worker 0” updates the weight parameters based on the transmitted information, and performs the Allgather process on the updated weight parameters.

Here, the processes described in i) to iv) are performed in parallel, and the execution order is not indicated. Similarly, the processes described in v) to viii) are performed in parallel, and the execution order is not indicated.

### (5) Details of Scheduling Process Performed by Scheduling Unit 303 (1)

Next, the scheduling performed by the scheduling unit 303 when performing the ReduceScatter process and the Allgather process in the training process using Micro-batches 0 to 3 will be described in detail. Here, the scheduling of the backward weight calculation executed in parallel with ReduceScatter process and Allgather process will also be described.

(5-1) Process performed by Worker Whose Name is “Worker 3”

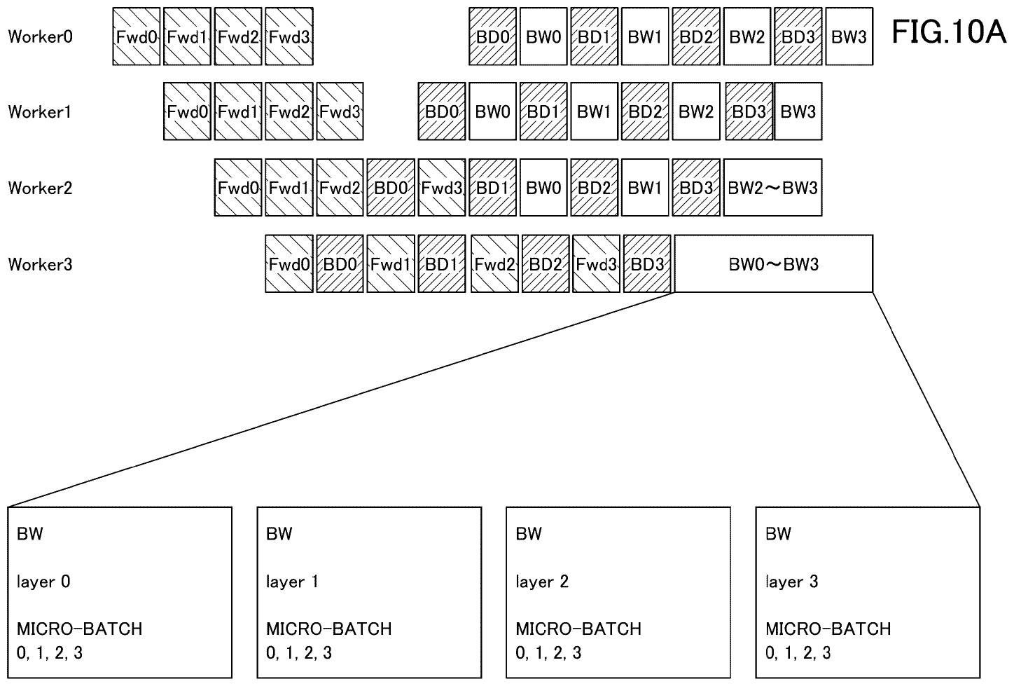

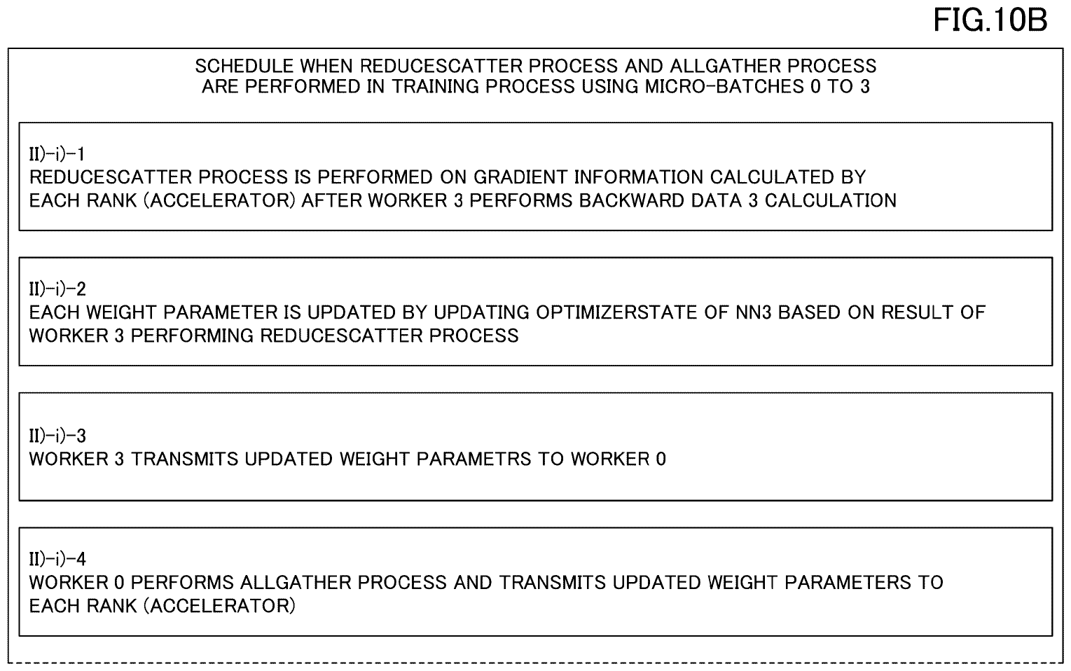

First, the scheduling of the backward weight calculation executed by the worker whose name is “Worker 3” will be described. FIG. 10A is a first diagram illustrating a specific example of scheduling the backward weight calculation executed by the worker whose name is “Worker 3”.

As illustrated in FIG. 10A, the scheduling unit 303 generates the following schedule as the backward weight calculation after the backward data calculation in the training process using Micro-batch 3 is completed.
The accelerators (Accelerators 0 to 3) included in the worker whose name is “Worker 3” perform backward weight calculations of a layer 0 included in NN3 in the training process using the micro-batches (Micro-batches 0 to 3).
The accelerators (Accelerators 0 to 3) included in the worker whose name is “Worker 3” perform backward weight calculations of a layer 1 included in NN3 in the training process using the micro-batches (Micro-batches 0 to 3).
The accelerators (Accelerators 0 to 3) included in the worker whose name is “Worker 3” perform backward weight calculations of a layer 2 included in NN3 in the training process using the micro-batches (Micro-batches 0 to 3).
The accelerators (Accelerators 0 to 3) included in the worker whose name is “Worker 3” perform backward weight calculations of a layer 3 included in NN3 in the training process using the micro-batches (Micro-batches 0 to 3).

Here, the layers 0 to 3 included in NN3 refer to layers in the backward weight calculation. In the training process using Micro-batch 3, after the backward data calculation is completed, the worker whose name is “Worker 3” performs the ReduceScatter process successively every time the gradient information on which the ReduceScatter process can be performed is calculated. Specifically, the worker whose name is “Worker 3” may perform the ReduceScatter process every time the backward weight calculation of each layer is completed, for example. That is, the ReduceScatter process may be performed every time the gradient information of one layer is calculated as the gradient information on which the ReduceScatter process can be performed. Alternatively, the worker whose name is “Worker 3” may perform the ReduceScatter process, for example, every time the backward weight calculation of half of one layer is performed. That is, the ReduceScatter process may be performed every time the gradient information of half of one layer is calculated as the gradient information on which the ReduceScatter process can be performed.

Next, a specific example of the scheduling of the ReduceScatter process and the Allgather process performed in parallel with the backward weight calculation executed by the worker whose name is “Worker 3” will be described. FIG. 10B is a first diagram illustrating a specific example of the scheduling of the ReduceScatter process and the Allgather process.

As illustrated in FIG. 10B, the scheduling unit 303 generates the following schedule as the ReduceScatter process and the Allgather process after the backward data calculation is completed in the training process using Micro-batch 3.

### II)-i)-1:

In the training process using the micro-batches (Micro-batches 0 to 3), the accelerators (Accelerators 0 to 3) of the worker whose name is “Worker 3” acquire the gradient information based on the backward data calculations and the backward weight calculations. The worker whose name is “Worker 3” performs the ReduceScatter process on the gradient information acquired by the accelerators (Accelerators 0 to 3).

### II)-i)-2:

The worker whose name is “Worker 3” updates the optimizer state of the NN3, using the gradient information on which the ReduceScatter process has been performed (an example of “the information acquired by performing the ReduceScatter process”). Additionally, the worker whose name is “Worker 3” converts the weight parameter included in the updated optimizer state.

### II)-i)-3:

The worker whose name is “Worker 3” transmits the updated weight parameters to the worker whose name is “Worker 0”.

### II)-i)-4:

The worker whose name is “Worker 0” performs the Allgather process on the updated weight parameters. With this, the worker whose name is “Worker 0” gathers the updated weight parameters and distributes the gathered weight parameters to the accelerators (Accelerators 0 to 3) included in the worker whose name is “Worker 0”.

### (5-2) Process Performed by Worker Whose Name is “Worker 2”

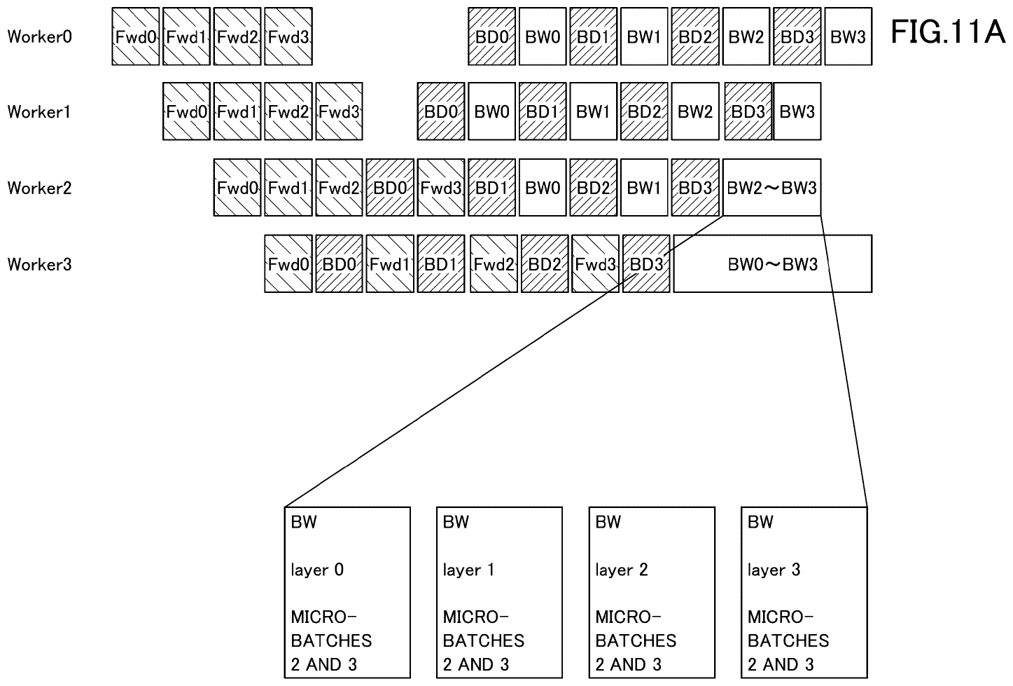

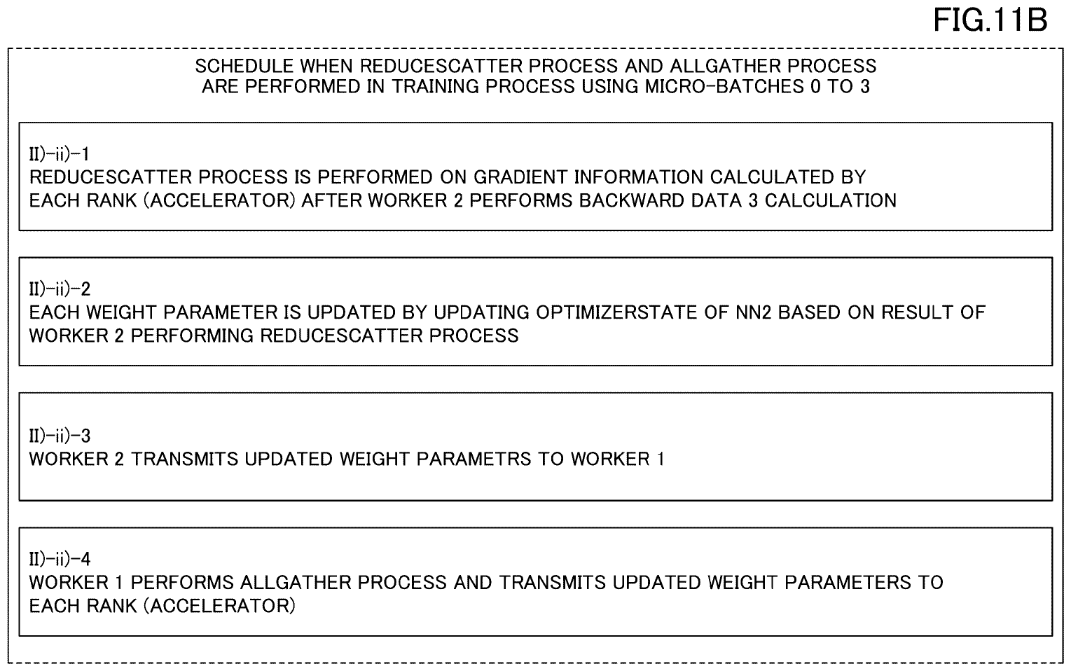

Next, the scheduling of the backward weight calculation executed by the worker whose name is “Worker 2” will be described. FIG. 11A is a first diagram illustrating a specific example of scheduling the backward weight calculation executed by the worker whose name is “Worker 2”.

As illustrated in FIG. 11A, the scheduling unit 303 generates the following schedule as the backward weight calculation after the backward data calculation in the training process using Micro-batch 3 is completed.
The accelerators (Accelerators 0 to 3) included in the worker whose name is “Worker 2” perform backward weight calculations of a layer 0 included in NN2 in the training process using the micro-batches (Micro-batches 2 and 3).
The accelerators (Accelerators 0 to 3) included in the worker whose name is “Worker 2” perform backward weight calculations of a layer 1 included in NN2 in the training process using the micro-batches (Micro-batches 2 and 3).
The accelerators (Accelerators 0 to 3) included in the worker whose name is “Worker 2” perform backward weight calculations of a layer 2 included in NN2 in the training process using the micro-batches (Micro-batches 2 and 3).
The accelerators (Accelerators 0 to 3) included in the worker whose name is “Worker 2” perform backward weight calculations of a layer 3 included in NN2 in the training process using the micro-batches (Micro-batches 2 and 3).

Here, the layers 0 to 3 included in NN2 refer to layers in the backward weight calculation. In the training process using Micro-batch 3, after the backward data calculation is completed, the worker whose name is “Worker 2” performs the ReduceScatter process successively every time the gradient information on which the ReduceScatter process can be performed is calculated. Specifically, the worker whose name is “Worker 2” may perform the ReduceScatter process every time the backward weight calculation of each layer is completed, for example. That is, the ReduceScatter process may be performed every time the gradient information of one layer is calculated as the gradient information on which the ReduceScatter process can be performed. Alternatively, the worker whose name is “Worker 2” may perform the ReduceScatter process every time the backward weight calculation of half of one layer is performed, for example. That is, the ReduceScatter process may be performed every time the gradient information of half of one layer is calculated as the gradient information on which the ReduceScatter process can be performed.

Next, a specific example of scheduling the ReduceScatter process and the Allgather process performed in parallel with the backward weight calculation executed by the worker whose name is “Worker 2” will be described. FIG. 11B is a second diagram illustrating a specific example of scheduling the ReduceScatter process and the Allgather process.

As illustrated in FIG. 11B, the scheduling unit 303 generates the following schedule as the ReduceScatter process and the Allgather process after the backward data calculation in the training process using Micro-batch 3 is completed.

### II)-ii)-1:

The accelerators (Accelerators 0 to 3) of the worker whose name is “Worker 2” acquire the gradient information based on the backward data calculations and the backward weight calculations in the training process using the micro-batches (Micro-batches 2 and 3). Additionally, the worker whose name is “Worker 2” performs the ReduceScatter process on the gradient information acquired by the accelerators (Accelerators 0 to 3).

### II)-ii)-2:

The worker whose name is “Worker 2” updates the optimizer state of NN2, using the gradient information on which the ReduceScatter process has been performed (an example of “the information acquired by performing the ReduceScatter process”). Additionally, the worker whose name is “Worker 2” converts the weight parameter included in the updated optimizer state.

### II)-ii)-3:

The worker whose name is “Worker 2” transmits the updated weight parameters to the worker whose name is “Worker 1”.

### II)-ii)-4:

The worker whose name is “Worker 1” performs the Allgather process on the updated weight parameters. With this, the worker whose name is “Worker 1” gathers the updated weight parameters and distributes the gathered weight parameters to the accelerators (Accelerators 0 to 3) included in the worker whose name is “Worker 1”.

### (5-3) Process Performed by Worker Whose Name is “Worker 1”

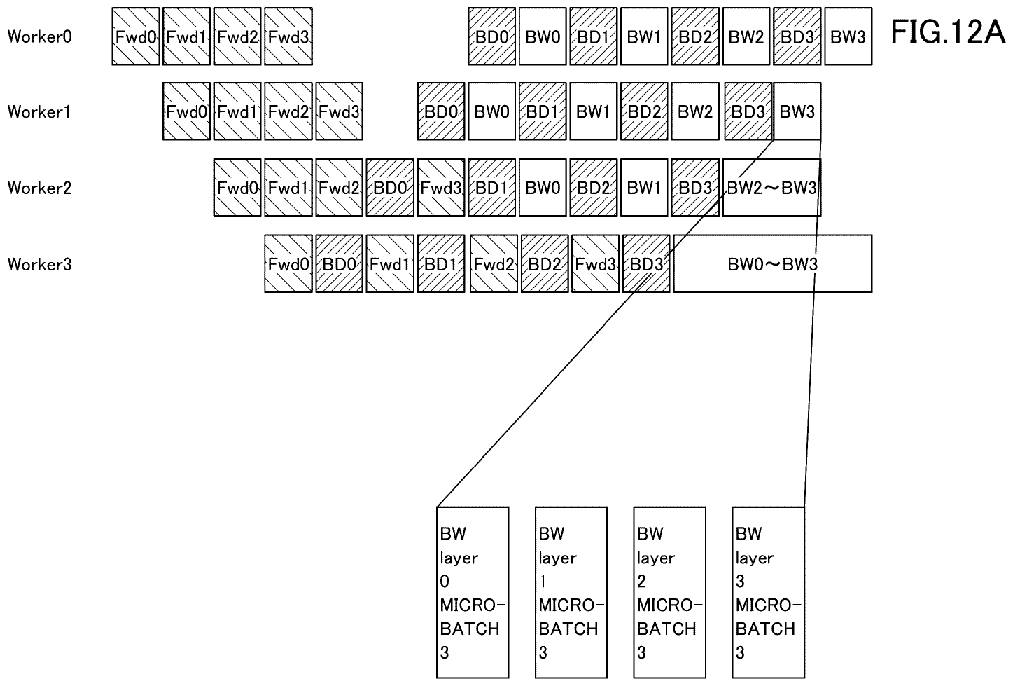

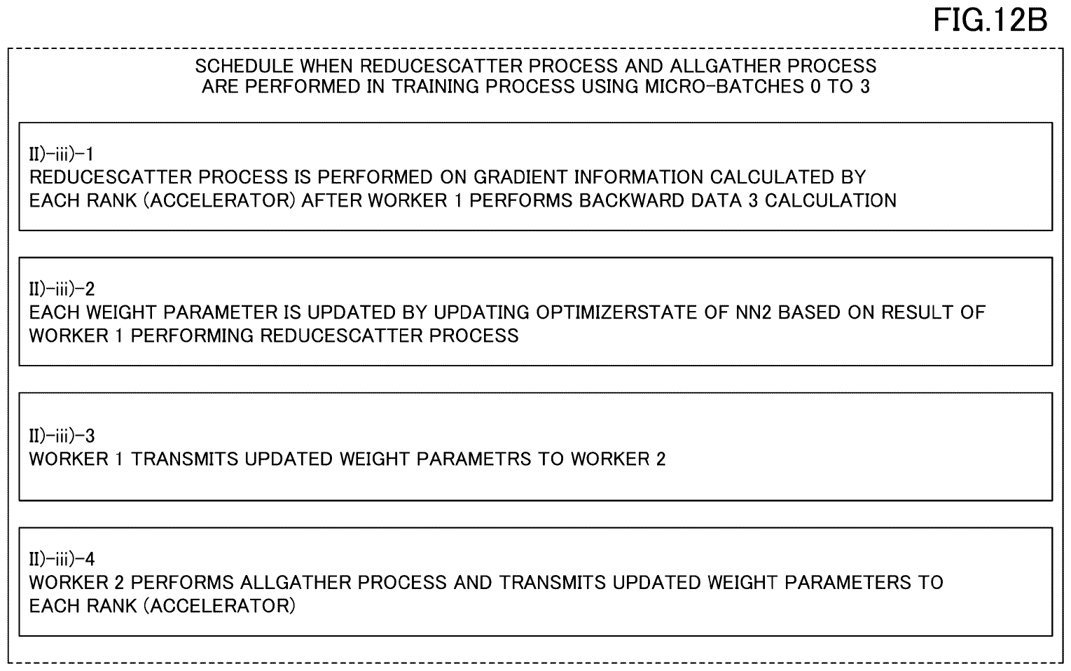

Next, the scheduling of backward weight calculation executed by the worker whose name is “Worker 1” will be described. FIG. 12A is a first diagram illustrating a specific example of scheduling the backward weight calculation executed by the worker whose name is “Worker 1”.

As illustrated in FIG. 12A, the scheduling unit 303 generates the following schedule as the backward weight calculation after the backward data calculation in the training process using Micro-batch 3 is completed.
The accelerators (Accelerators 0 to 3) included in the worker whose name is “Worker 1” perform backward weight calculations of a layer 0 included in NN1 in the training process using the micro-batch (Micro-batch 3).
The accelerators (Accelerators 0 to 3) included in the worker whose name is “Worker 1” perform backward weight calculations of a layer 1 included in NN1 in the training process using the micro-batch (Micro-batch 3).
The accelerators (Accelerators 0 to 3) included in the worker whose name is “Worker 1” perform backward weight calculations of a layer 2 included in NN1 in the training process using the micro-batch (Micro-batch 3).
The accelerators (Accelerators 0 to 3) included in the worker whose name is “Worker 1” perform backward weight calculations of a layer included in NN1 in the training process using the micro-batch (Micro-batch 3).

Here, the layers 0 to 3 included in NN1 refer to layers in the backward weight calculation. In the training process using Micro-batch 3, after the backward data calculation is completed, the worker whose name is “Worker 1” performs the ReduceScatter process successively every time the gradient information on which the ReduceScatter process can be performed is calculated. Specifically, the worker whose name is “Worker 1” may perform the ReduceScatter process every time the backward weight calculation of each layer is completed, for example. That is, the ReduceScatter process may be performed every time the gradient information of one layer is calculated as the gradient information on which the ReduceScatter process can be performed. Alternatively, the worker whose name is “Worker 1” may perform the ReduceScatter process every time the backward weight calculation of half of one layer is performed, for example. That is, the ReduceScatter process may be performed every time the gradient information of half of one layer is calculated as the gradient information on which the ReduceScatter process can be performed.

Next, a specific example of scheduling the ReduceScatter process and the Allgather process performed in parallel with the backward weight calculation executed by the worker whose name is “Worker 1” will be described. FIG. 12B is a third diagram illustrating a specific example of scheduling the ReduceScatter process and the Allgather process.

As illustrated in FIG. 12B, the scheduling unit 303 generates the following schedule as the ReduceScatter process and Allgather process after the backward data calculation is completed in the training process using Micro-batch 3.

### II)-iii)-1:

The accelerators (Accelerators 0 to 3) included in the worker whose name is “Worker 1” acquire the gradient information based on the backward data calculations and the backward weight calculations in the training process using the micro-batch (Micro-batch 3). Additionally, the worker whose name is “Worker 1” performs the ReduceScatter process on the gradient information acquired by the accelerators (Accelerators 0 to 3).

### II)-iii)-2:

The worker whose name is “Worker 1” updates an optimizer state of NN1, using the gradient information on which the ReduceScatter process has been performed (an example of “the information acquired by performing the ReduceScatter process”). Additionally, the worker whose name is “Worker 1” converts the weight parameter included in the updated optimizer state.

### II)-iii)-3:

The worker whose name is “Worker 1” transmits the updated weight parameters to the worker whose name is “Worker 2”.

### II)-iii)-4:

The worker whose name is “Worker 2” performs the Allgather process on the updated weight parameters. With this, the worker whose name is “Worker 2” gathers the updated weight parameters and distributes the gathered weight parameters to the accelerators (Accelerators 0 to 3) included in the worker whose name is “Worker 2”.

### (5-4) Process Performed by Worker Whose Name is “Worker 0”

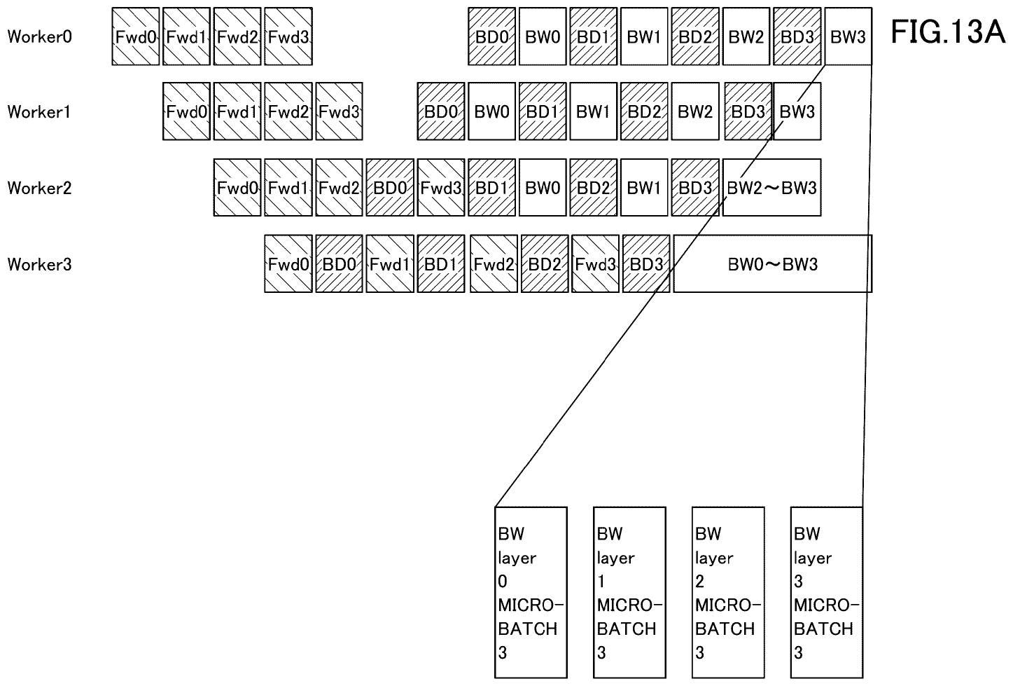

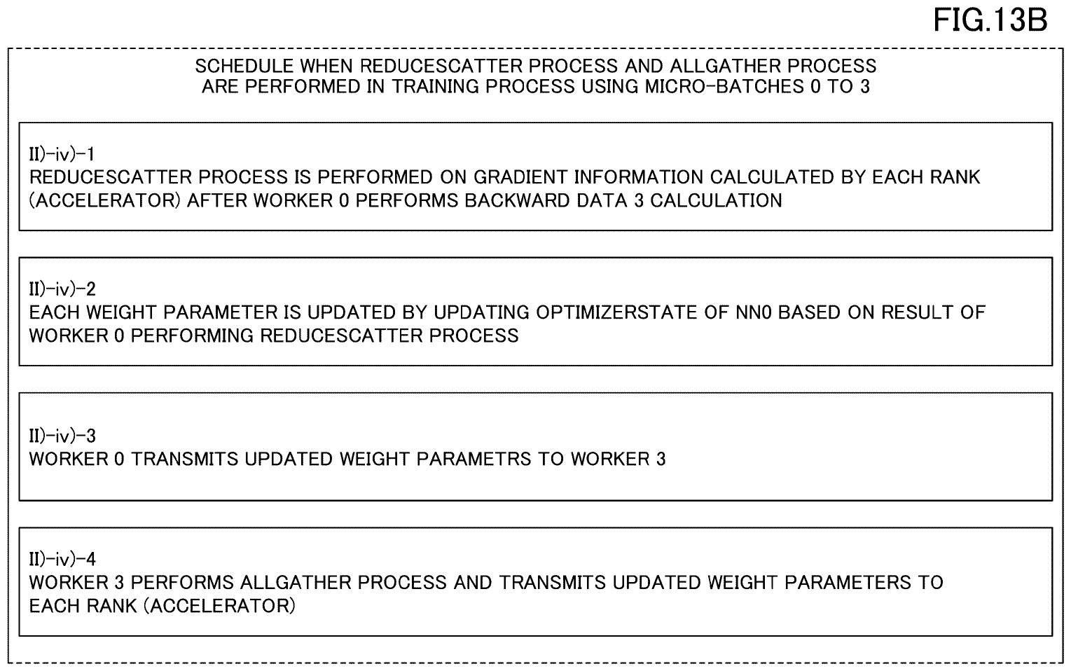

Next, the scheduling of the backward weight calculation executed by the worker whose name is “Worker 0” will be described. FIG. 13A is a first diagram illustrating a specific example of scheduling the backward weight calculation executed by the worker whose name is “Worker 0”.

As illustrated in FIG. 13A, the scheduling unit 303 generates the following schedule as the backward weight calculation after the backward data calculation in the training process using Micro-batch 3 is completed.
The accelerators (Accelerators 0 to 3) included in the worker whose name is “Worker 0” perform backward weight calculations of a layer 0 included in NN0 in the training process using the micro-batch (Micro-batch 3).
The accelerators (Accelerators 0 to 3) included in the worker whose name is “Worker 0” perform the backward weight calculations of a layer 1 included in NN0 in the training process using the micro-batch (Micro-batch 3).
The accelerators (Accelerators 0 to 3) included in the worker whose name is “Worker 0” perform the backward weight calculations of a layer 2 included in NN0 in the training process using the micro-batch (Micro-batch 3).
The accelerators (Accelerators 0 to 3) included in the worker whose name is “Worker 0” perform the backward weight calculations of a layer 3 included in NN0 in the training process using the micro-batch (Micro-batch 3).

Here, the layers 0 to 3 included in NN0 refer to layers in the backward weight calculation. In the training process using Micro-batch 3, after the backward data calculation is completed, the worker whose name is “Worker 0” performs the ReduceScatter process successively every time the gradient information on which the ReduceScatter process can be performed is calculated. Specifically, the worker whose name is “Worker 0” may perform the ReduceScatter process every time the backward weight calculation of each layer is completed, for example. That is, the ReduceScatter process may be performed every time the gradient information of one layer is calculated as the gradient information on which the ReduceScatter process can be performed. Alternatively, the worker whose name is “Worker 0” may perform the ReduceScatter process every time the backward weight calculation of half of one layer is performed, for example. That is, the ReduceScatter process may be performed every time the gradient information of half of one layer is calculated as the gradient information on which the ReduceScatter process can be performed.

Next, a specific example of scheduling the ReduceScatter process and the Allgather process performed in parallel with the backward weight calculation executed by the worker whose name is “Worker 0” will be described. FIG. 13B is a fourth diagram illustrating a specific example of scheduling the ReduceScatter process and the Allgather process.

As illustrated in FIG. 13B, the scheduling unit 303 generates the following schedule as the ReduceScatter process and the Allgather process after the backward data calculation is completed in the training process using Micro-batch 3.

### II)-iv)-1:

In the training process using the micro-batch (Micro-batch 3), the accelerators (Accelerators 0 to 3) included in the worker whose name is “Worker 0” acquire the gradient information based on the backward data calculations and the backward weight calculations. Additionally, the worker whose name is “Worker 0” performs the ReduceScatter process on the gradient information acquired by the accelerators (Accelerators 0 to 3).

### II)-iv)-2:

The worker whose name is “Worker 0” updates an optimizer state of NN0, using the gradient information on which the ReduceScatter process has been performed (an example of “the information acquired by performing the ReduceScatter process”). Additionally, the worker whose name is “Worker 0” converts the weight parameter included in the updated optimizer state.

### II)-iv)-3:

The worker whose name is “Worker 0” transmits the updated weight parameters to the worker whose name is “Worker 3”.

### II)-iv)-4:

The worker whose name is “Worker 3” performs the Allgather process on the updated weight parameters. With this, the worker whose name is “Worker 3” gathers the updated weight parameters and distributes the gathered weight parameters to the accelerators (Accelerators 0 to 3) included in the worker whose name is “Worker 3”.

### (6) Details of Scheduling Process Performed by Scheduling Unit 303 (2)

Next, the scheduling performed by the scheduling unit 303 when performing the ReduceScatter process and the Allgather process in the training process using Micro-batches 4 to 7 will be described in detail.

Here, the training process using Micro-batches 4 to 7 is basically the same as the training process using Micro-batches 0 to 3. However, as is clear from the above description, in the training process using Micro-batches 0 to 3, the worker whose name is “Worker 3” holds the updated weight parameters of NN0. Therefore, when scheduling the training process using Micro-batches 4 to 7, the scheduling unit 303 first schedules the worker whose name is “Worker 3” to start the forward calculation. As a result, the worker whose name is “Worker 0” first completes the backward data calculation in the training process using Micro-batch 7, and the worker whose name is “Worker 0” first starts the ReduceScatter process.

Additionally, the optimizer state of the worker is the optimizer state to be updated using the gradient information on which the ReduceScatter process has been performed by a source worker when the worker becomes a transmission destination (see FIG. 5B). Therefore, in the training process using Micro-batches 4 to 7, the scheduling unit 303 performs scheduling such that each of the workers transmits, to a transmission destination worker, the gradient information on which the ReduceScatter process has been performed, without using it to update the optimizer state.

(6-1) Process performed by Worker Whose Name is “Worker 0”

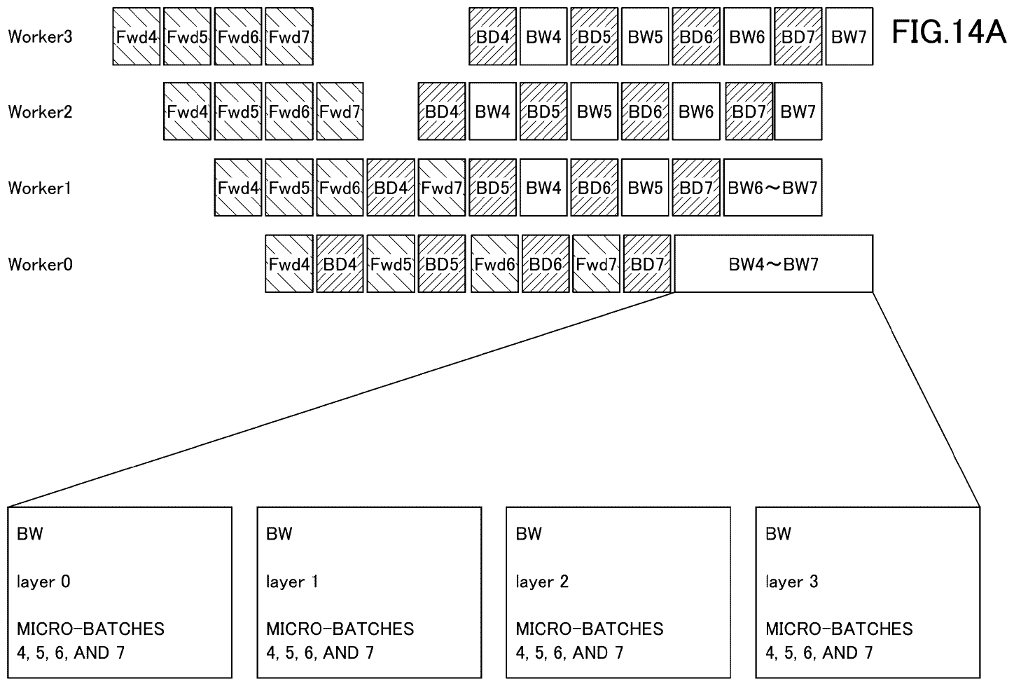

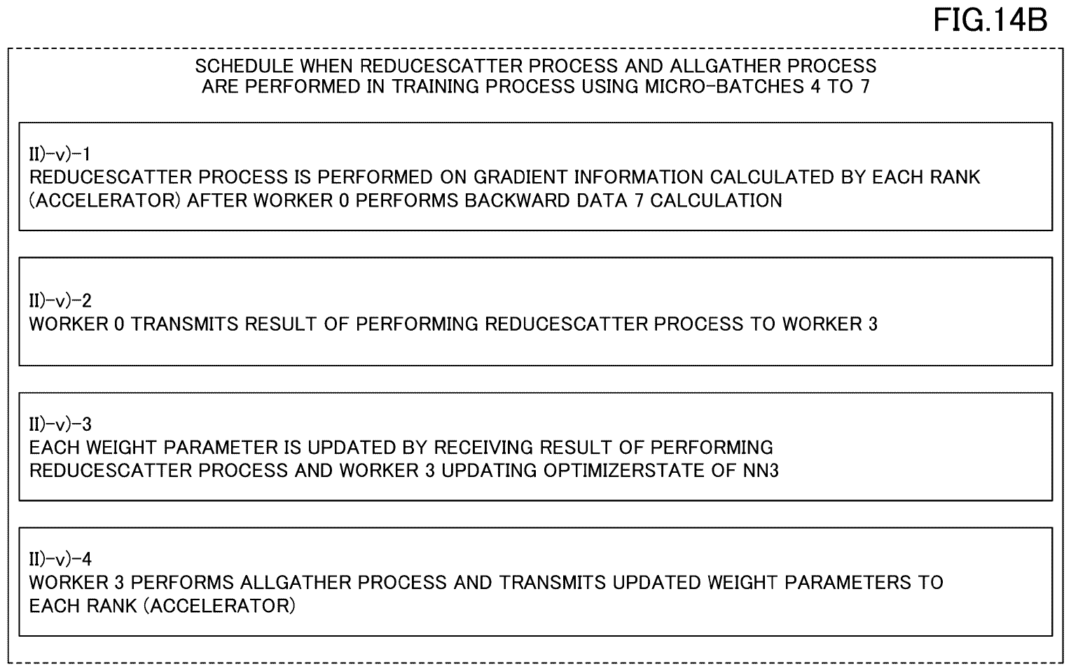

First, the scheduling of the backward weight calculation executed by the worker whose name is “Worker 0” will be described. FIG. 14A is a second diagram illustrating a specific example of scheduling the backward weight calculation executed by the worker whose name is “Worker 0”.

As illustrated in FIG. 14A, the scheduling unit 303 generates the following schedule as the backward weight calculation after the backward data calculation is completed in the training process using Micro-batch 7.
The accelerators (Accelerators 0 to 3) of the worker whose name is “Worker 0” perform backward weight calculations of a layer 0 included in NN3 in the training process using the micro-batches (Micro-batches 4 to 7).
The accelerators (Accelerators 0 to 3) of the worker whose name is “Worker 0” perform backward weight calculations of a layer 1 included in NN3 in the training process using the micro-batches (Micro-batches 4 to 7).
The accelerators (Accelerators 0 to 3) of the worker whose name is “Worker 0” perform backward weight calculations of a layer 2 included in NN3 in the training process using the micro-batches (Micro-batches 4 to 7).
The accelerators (Accelerators 0 to 3) of the worker whose name is “Worker 0” perform backward weight calculations of a layer 3 included in NN3 in the training process using the micro-batches (Micro-batches 4 to 7).

Here, the layers 0 to 3 included in NN3 refer to layers in the backward weight calculation. In the training process using Micro-batch 7, after the backward data calculation is completed, the worker whose name is “Worker 0” performs the ReduceScatter process successively every time the gradient information on which the ReduceScatter process can be performed is calculated. Specifically, the worker whose name is “Worker 0” may perform the ReduceScatter process every time the backward weight calculation of each layer is completed, for example. That is, the ReduceScatter process may be performed every time the gradient information of one layer is calculated as the gradient information on which the ReduceScatter process can be performed is calculated. Alternatively, the worker whose name is “Worker 0” may perform the ReduceScatter process every time the backward weight calculation of half of one layer is performed, for example. That is, the ReduceScatter process may be performed every time the gradient information of half of one layer is calculated as the gradient information on which the ReduceScatter process can be performed is calculated.

Next, a specific example of scheduling the ReduceScatter process and the Allgather process performed in parallel with the backward weight calculation executed by the worker whose name is “Worker 0” will be described. FIG. 14B is a fifth diagram illustrating a specific example of scheduling the ReduceScatter process and the Allgather process.

As illustrated in FIG. 14B, the scheduling unit 303 generates the following schedule as the ReduceScatter process and the Allgather process after the backward data calculation is completed in the training process using Micro-batch 7.

### II)-v)-1:

The accelerators (Accelerators 0 to 3) included in the worker whose name is “Worker 0” acquire the gradient information based on the backward data calculations and the backward weight calculations in the training process using the micro-batches (Micro-batches 4 to 7). The worker whose name is “Worker 0” performs the ReduceScatter process on the gradient information acquired by the accelerators (Accelerators 0 to 3).

### II)-v)-2:

The accelerators (Accelerators 0 to 3) included in the worker whose name is “Worker 0” transmits, to the worker whose name is “Worker 3”, the gradient information on which the ReduceScatter process has been performed.

### II)-v)-3:

The worker whose name is “Worker 3” updates an optimizer state of NN3, using the gradient information on which the ReduceScatter process has been performed. By updating the optimizer state, various parameters including the weight parameter included in the optimizer state are updated. Additionally, the worker whose name is “Worker 3” converts the weight parameter included in the updated optimizer state.

### II)-v)-4:

The worker whose name is “Worker 3” performs the Allgather process on the updated weight parameters. With this, the worker whose name is “Worker 3” gathers the updated weight parameters and distributes the gathered weight parameters to the accelerators (Accelerators 0 to 3) included in the worker whose name is “Worker 3”.

### (6-2) Process Performed by Worker Whose Name is “Worker 1”

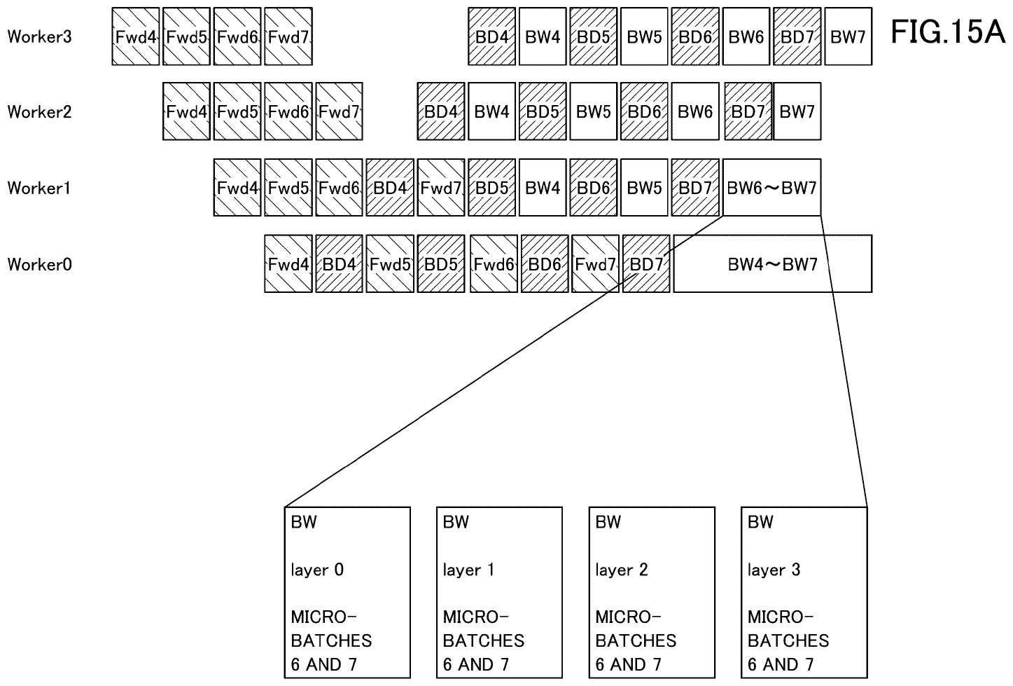

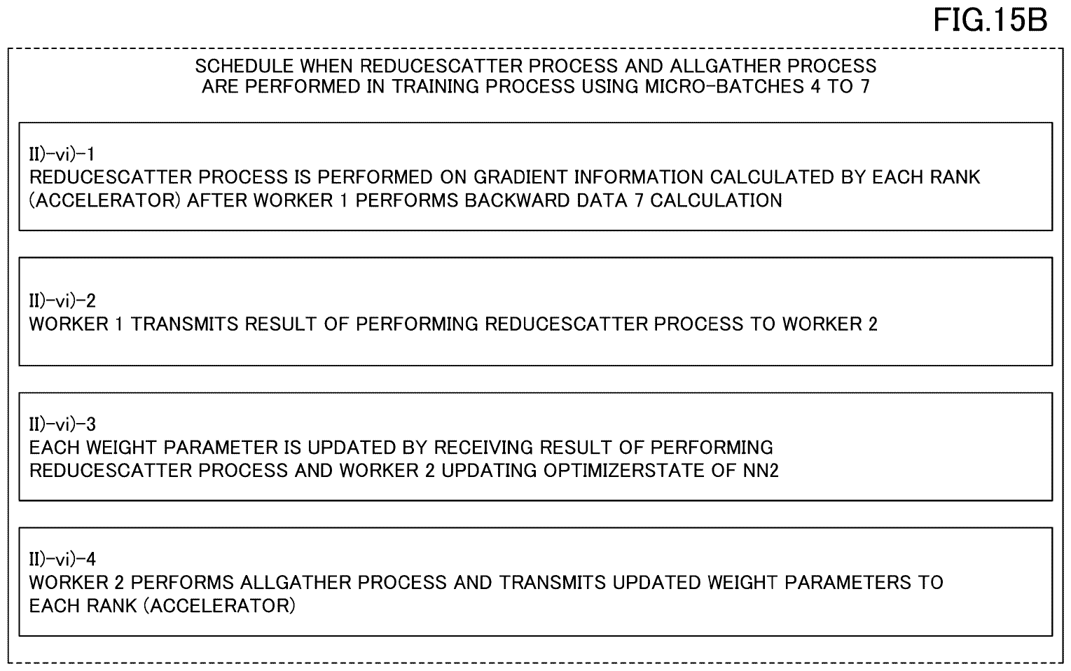

Next, the scheduling of the backward weight calculation executed by the worker whose name is “Worker 1” will be described. FIG. 15A is a second diagram illustrating a specific example of scheduling the backward weight calculation executed by the worker whose name is “Worker 1”.

As illustrated in FIG. 15A, the scheduling unit 303 generates the following schedule as the backward weight calculation after the backward data calculation is completed in the training process using Micro-batch 7.
The accelerators (Accelerators 0 to 3) included in the worker whose name is “Worker 1” perform backward weight calculations of a layer 0 included in NN2 in the training process using the micro-batches (Micro-batch 6 and 7).
The accelerators (Accelerators 0 to 3) included in the worker whose name is “Worker 1” perform backward weight calculations of a layer 1 included in NN2 in the training process using the micro-batches (Micro-batch 6 and 7).
The accelerators (Accelerators 0 to 3) included in the worker whose name is “Worker 1” perform backward weight calculations of a layer 2 included in NN2 in the training process using the micro-batches (Micro-batches 6 and 7).
The accelerators (Accelerators 0 to 3) included in the worker whose name is “Worker 1” perform backward weight calculations of a layer 3 included in NN2 in the training process using the micro-batches (Micro-batch 6 and 7).

Here, the layers 0 to 3 included in NN2 refer to layers in the backward weight calculation. In the training process using Micro-batch 7, after the backward data calculation is completed, the worker whose name is “Worker 1” performs the ReduceScatter process successively every time the gradient information on which the ReduceScatter process can be performed is calculated. Specifically, the worker whose name is “Worker 1” may perform the ReduceScatter process every time the backward weight calculation of each layer is completed, for example. That is, the ReduceScatter process may be performed every time the gradient information of one layer is calculated as the gradient information on which the ReduceScatter process can be performed. Alternatively, the worker whose name is “Worker 1” may perform the ReduceScatter process every time the backward weight calculation of half of one layer is performed, for example. That is, the ReduceScatter process may be performed every time the gradient information of half of one layer is calculated as the gradient information on which the ReduceScatter process can be performed.

Next, a specific example of scheduling the ReduceScatter process and the Allgather process performed in parallel with the backward weight calculation executed by the worker whose name is “Worker 1” will be described. FIG. 15B is a sixth diagram illustrating a specific example of scheduling the ReduceScatter process and the Allgather process.

As illustrated in FIG. 15B, the scheduling unit 303 generates the following schedule as the ReduceScatter process and the Allgather process after the backward data calculation is completed in the training process using Micro-batch 7.

### II)-vi)-1:

The accelerators (Accelerators 0 to 3) of the worker whose name is “Worker 1” acquire the gradient information based on the backward data calculations and the backward weight calculations in the training process using the micro-batches (Micro-batches 6 and 7). Additionally, the worker whose name is “Worker 1” performs the ReduceScatter process on the gradient information acquired by the accelerators (Accelerators 0 to 3).

### II)-vi)-2:

The accelerators (Accelerators 0 to 3) of the worker whose name is “Worker 1” transmit, to the worker whose name is “Worker 2”, the gradient information on which the ReduceScatter process has been performed.

### II)-vi)-3:

The worker whose name is “Worker 2” updates an optimizer state of NN2, using the gradient information on which the ReduceScatter process has been performed. By updating the optimizer state, various parameters including the weight parameter included in the optimizer state are updated. Additionally, the worker whose name is “Worker 2” converts the weight parameter included in the updated optimizer state.

### II)-vi)-4:

The worker whose name is “Worker 2” performs the Allgather process on the updated weight parameters. With this, the worker whose name is “Worker 2” gathers the updated weight parameters and distributes the gathered weight parameters to the accelerators (Accelerators 0 to 3) included in the worker whose name is “Worker 2”.

### (6-3) Process Performed by Worker Whose Name is “Worker 2”

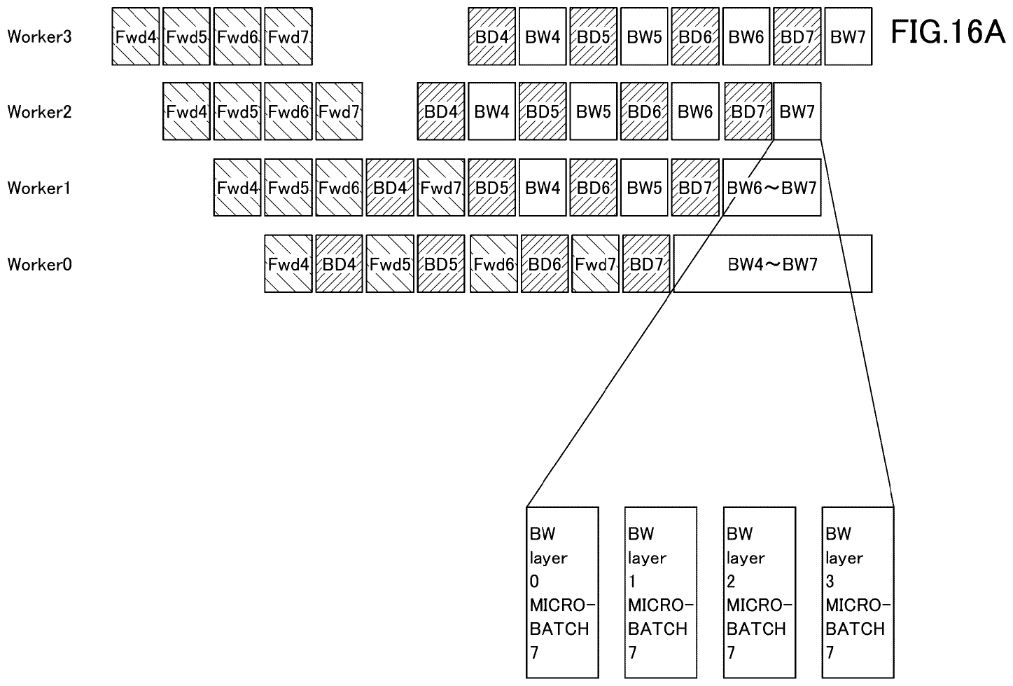

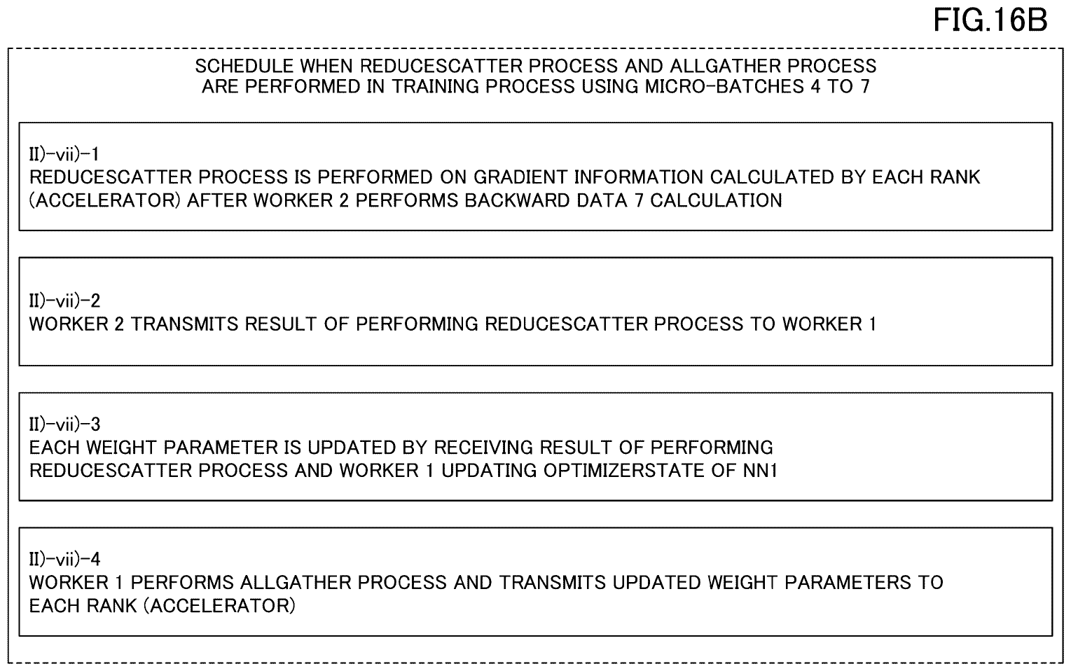

Next, the scheduling of the backward weight calculation executed by the worker whose name is “Worker 2” will be described. FIG. 16A is a second diagram illustrating a specific example of scheduling the backward weight calculation executed by the worker whose name is “Worker 2”.

As illustrated in FIG. 16A, the scheduling unit 303 generates the following schedule as the backward weight calculation after the backward data calculation is completed in the training process using Micro-batch 7.
The accelerators (Accelerators 0 to 3) of the worker whose name is “Worker 2” perform backward weight calculations of a layer 0 included in NN1 in the training process using the micro-batch (Micro-batch 7).
The accelerators (Accelerators 0 to 3) of the worker whose name is “Worker 2” perform backward weight calculations of a layer 1 included in NN1 in the training process using the micro-batch (Micro-batch 7).
The accelerators (Accelerators 0 to 3) of the worker whose name is “Worker 2” perform backward weight calculations of a layer 2 included in NN1 in the training process using the micro-batch (Micro-batch 7).
The accelerators (Accelerators 0 to 3) of the worker whose name is “Worker 2” perform backward weight calculations of a layer 3 included in NN1 in the training process using the micro-batch (Micro-batch 7).

Here, layers 0 to 3 included in NN1 refer to layers in the backward weight calculation. In the training process using Micro-batch 7, after the backward data calculation is completed, the worker whose name is “Worker 2” performs the ReduceScatter process successively every time the gradient information on which the ReduceScatter process can be performed is calculated. Specifically, the worker whose name is “Worker 2” may perform the ReduceScatter process every time the backward weight calculation of each layer is completed, for example. That is, the ReduceScatter process may be performed every time the gradient information of one layer is calculated as the gradient information on which the ReduceScatter process can be performed. Alternatively, the worker whose name is “Worker 2” may perform the ReduceScatter process every time the backward weight calculation of half of one layer is calculated, for example. That is, the ReduceScatter process may be performed every time the gradient information of half of one layer is calculated as the gradient information on which the ReduceScatter process can be performed.

Next, a specific example of scheduling the ReduceScatter process and the Allgather process performed in parallel with the backward weight calculation executed by the worker whose name is “Worker 2” will be described. FIG. 16B is a seventh diagram illustrating a specific example of scheduling the ReduceScatter process and the Allgather process.

As illustrated in FIG. 16B, the scheduling unit 303 generates the following schedule as the ReduceScatter process and the Allgather process after the backward data calculation is completed in the training process using Micro-batch 7.

### II)-vii)-1:

The accelerators (Accelerators 0 to 3) included in the worker whose name is “Worker 2” acquire the gradient information based on the backward data calculations and the backward weight calculations in the training process using the micro-batch (Micro-batch 7). The worker whose name is “Worker 2” performs the ReduceScatter process on the gradient information acquired by the accelerators (Accelerators 0 to 3).

### II)-vii)-2:

The accelerators (Accelerators 0 to 3) included in the worker whose name is “Worker 2” transmit, to the worker whose name is “Worker 1”, the gradient information on which the ReduceScatter process has been performed.

### II)-vii)-3:

The worker whose name is “Worker 1” updates an optimizer state of NN1, using the gradient information on which the ReduceScatter process has been performed. By updating the optimizer state, various parameters including the weight parameter included in the optimizer state are updated. Additionally, the worker whose name is “Worker 1” converts the weight parameter included in the updated optimizer state.

### II)-vii)-4:

The worker whose name is “Worker 1” performs the Allgather process on the updated weight parameters. With this, the worker whose name is “Worker 1” gathers the updated weight parameters and distributes the gathered weight parameters to the accelerators (Accelerators 0 to 3) included in the worker whose name is “Worker 1”.

(6-4) Process performed by Worker Whose Name is “Worker 3”

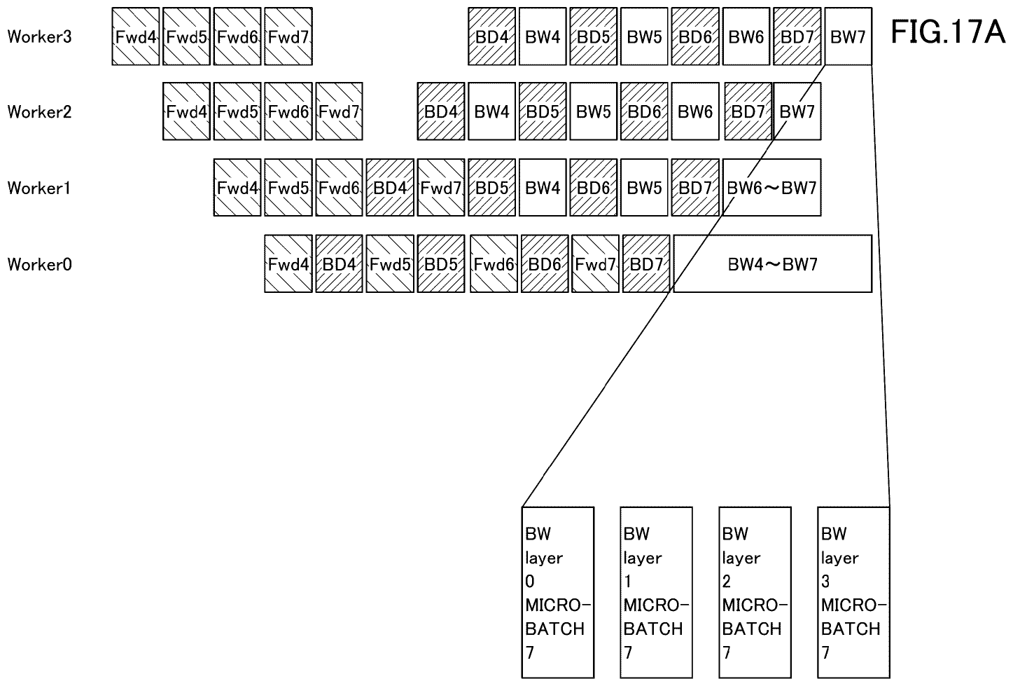

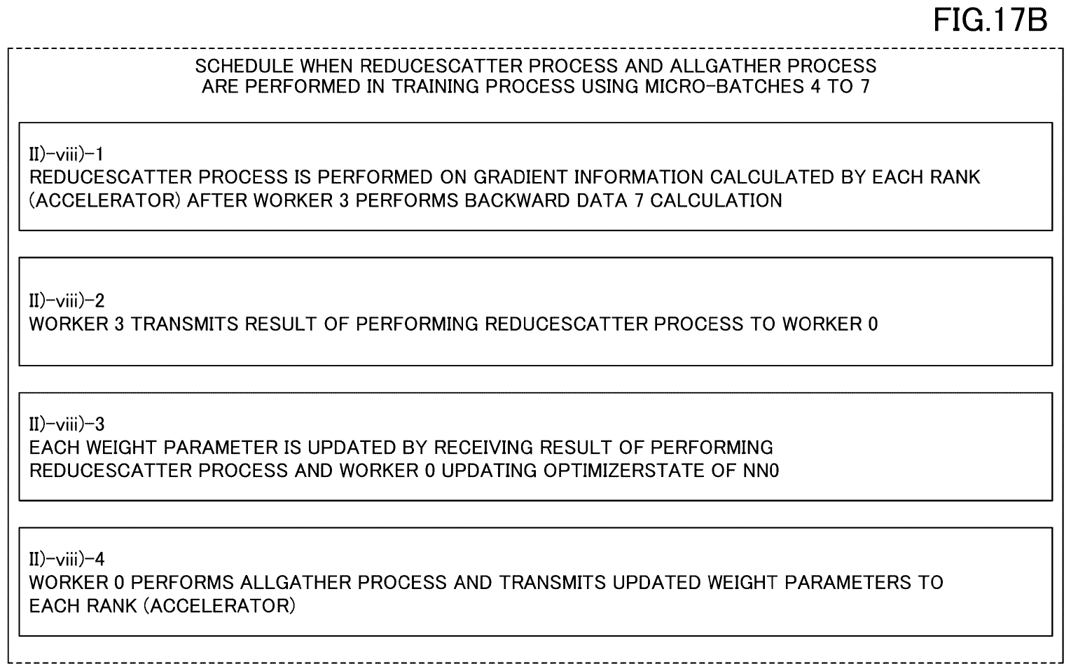

Next, the scheduling of the backward weight calculation executed by the worker whose name is “Worker 3” will be described. FIG. 17A is a second diagram illustrating a specific example of scheduling the backward weight calculation executed by the worker whose name is “Worker 3”.

As illustrated in FIG. 17A, the scheduling unit 303 generates the following schedule as the backward weight calculation after the backward data calculation is completed in the training process using Micro-batch 7.
The accelerators (Accelerators 0 to 3) of the worker whose name is “Worker 3” perform backward weight calculations of a layer 0 included in NN0 in the training process using the micro-batch (Micro-batch 7).
The accelerators (Accelerators 0 to 3) of the worker whose name is “Worker 3” perform backward weight calculations of a layer 1 included in NN0 in the training process using the micro-batch (Micro-batch 7).
The accelerators (Accelerators 0 to 3) of the worker whose name is “Worker 3” perform backward weight calculations of a layer 2 included in NN0 in the training process using the micro-batch (Micro-batch 7).
The accelerators (Accelerators 0 to 3) of the worker whose name is “Worker 3” perform backward weight calculations of a layer 3 included in NN0 in the training process using the micro-batch (Micro-batch 7).

Here, the layers 0 to 3 included in NN0 refer to layers in the backward weight calculation. In the training process using Micro-batch 7, after the backward data calculation is completed, the worker whose name is “Worker 3” performs the ReduceScatter process successively every time the gradient information on which the ReduceScatter process can be performed is calculated. Specifically, the worker whose name is “Worker 3” may perform the ReduceScatter process every time the backward weight calculation of each layer is completed, for example. That is, the ReduceScatter process may be performed every time the gradient information of one layer is calculated as the gradient information on which the ReduceScatter process can be performed. Alternatively, the worker whose name is “Worker 3” may perform the ReduceScatter process every time the backward weight calculation of half of one layer is performed, for example. That is, the ReduceScatter process may be performed every time the gradient information of half of one layer is calculated as the gradient information on which the ReduceScatter process can be performed.

Next, a specific example of scheduling the ReduceScatter process and the Allgather process performed in parallel with the backward weight calculation executed by the worker whose name is “Worker 3” will be described. FIG. 17B is a diagram 8 illustrating a specific example of scheduling the ReduceScatter process and the Allgather process.

As illustrated in FIG. 17B, the scheduling unit 303 generates the following schedule as the ReduceScatter process and the Allgather process after the backward data calculation is completed in the training process using Micro-batch 7.

II)-viii)-1:

The accelerators (Accelerators 0 to 3) of the worker whose name is “Worker 3” acquire the gradient information based on the backward data calculations and the backward weight calculations of the micro-batch (Micro-batch 7). Additionally, the worker whose name is “Worker 3” performs the ReduceScatter process on the gradient information acquired by the accelerators (Accelerators 0 to 3).

II)-viii)-2:

The accelerators (Accelerators 0 to 3) included in the worker whose name is “Worker 3” transmit, to the worker whose name is “Worker 0”, the gradient information on which the ReduceScatter process has been performed.

II)-viii)-3:

The worker whose name is “Worker 0” updates an optimizer state of NN0, using the gradient information on which the ReduceScatter process has been performed. By updating the optimizer state, various parameters including the weight parameter included in the optimizer state are updated. Additionally, the worker whose name is “Worker 0” converts each weight parameter included in the updated optimizer state.

II)-viii)-4:

The worker whose name is “Worker 0” performs the Allgather process on the updated weight parameters. With this, the worker whose name is “Worker 0” gathers the updated weight parameters and distributes the gathered weight parameters to the accelerators (Accelerators 0 to 3) included in the worker whose name is “Worker 0”.

### <Summary>

As is clear from the above description, the information processing system 100 according to the first embodiment performs a training process of a neural network, using at least a first worker (for example, “Worker 0”) and a second worker (for example, “Worker 3”).
The first worker (for example, “Worker 0”) is configured to:
   perform forward processing for first data (for example, data processed by the first worker in the training process using Micro-batch 0), using first parameters of the neural network to generate a first output; and
   perform forward processing for second data (for example, data processed by the first worker in the training process using Micro-batch 1), using the first parameters to generate a second output.
The second worker (for example, “Worker 3”) is configured to:
   perform forward processing based on the first output, using second parameters of the neural network to generate a third output;
   execute forward processing based on the second output, using the second parameters to generate a fourth output;
   generate gradient information of the second parameters based on the third output and the fourth output (for example, generate the gradient information of the second parameters by back-propagating the error between the information generated by the forward processing of the worker and the correct data);
   perform a first process (for example, the ReduceScatter process) on the gradient information to update the second parameters (for example, the weight parameters); and
   transmit the updated second parameters (for example, the updated weight parameters) to the first worker (for example, “Worker 0”).
The first worker (for example, “Worker 0”) performs a second process (for example, the Allgather process), using the updated second parameters (for example, the updated weight parameters) received from the second worker (for example, “Worker 3”). Here, the first to fourth outputs are information generated by executing the forward processing, and may be intermediate data, for example. Additionally, the third and fourth outputs may be data output from the final layer.

Additionally, the information processing system 100 according to the first embodiment performs a training process of a neural network using at least a first worker (for example, “Worker 3”) and a second worker (for example, “Worker 0”).
The first worker (for example, “Worker 3”) is configured to:
   perform forward processing for first data (for example, data processed by the first worker in the training process using Micro-batch 4), using first parameters of the neural network to generate a first output; and
   perform forward processing for second data (for example, data processed by the first worker in the training process using Micro-batch 5), using the first parameters to generate a second output.
The second worker (for example, “Worker 0”) is configured to:
   perform forward processing based on the first output, using second parameters of the neural network to generate a third output;
   perform forward processing based on the second output, using the second parameters to generate a fourth output;
   generate gradient information of the second parameters based on the third output and the fourth output (for example, generate the gradient information of the second parameters by back-propagating the error between the information generated by the forward processing of the worker and the correct data); and
   perform a first process (for example, the ReduceScatter process) on the gradient information, and transmit a result of performing the first process to the first worker (for example, “Worker 3”), and
   the first worker (for example, “Worker 3”) updates the second parameters (for example, the weight parameters), using the result received from the second worker (for example, “Worker 0”), and performs a second process (for example, the Allgather process), using the updated second parameters (for example, the updated weight parameters). Here, the process of transmitting, to the first worker, the result of performing the first process includes:
a process of transmitting the gradient information itself;
a process of transmitting information obtained by compressing the gradient information (in this case, decompression is performed at a receiver); or
a process of transmitting information from which the gradient information can be restored or acquired (in this case, restoration or acquisition is performed at a receiver).

As described, in the information processing system 100 according to the first embodiment, the ReduceScatter process and the Allgather process are performed by different workers. With this, according to the information processing system 100 of the first embodiment, when the model training process is performed by combining data parallelism and pipeline parallelism, the network bandwidth between the workers can be effectively utilized. As a result, according to the information processing system 100 of the first embodiment, the training speed when the model training process is performed by combining data parallelism and pipeline parallelism can be improved.

### Second Embodiment

In the first embodiment, the description assumes that each of the workers has an optimizer state of corresponding “NN” and updates the optimizer state when updating the weight parameters in the training process using the micro-batches. If each of the workers does not have an optimizer state of corresponding “NN”, each of the workers may acquire the optimizer state of “NN” from another worker. In this case, each of the workers may update the weight parameters by updating the optimizer state acquired from another worker in the training process using the micro-batches. Alternatively, each of the workers may instruct another worker to update the weight parameters in the training process using the micro-batches and acquire the update result. Here, another worker may be a worker other than the workers whose names are “Worker 0” to “Worker 3”, or one or more workers among the workers whose names are “Worker 0” to “Worker 3”.

### Third Embodiment

In the above-described embodiments, the case where the information processing device 120 generates the schedule of the ReduceScatter process and the Allgather process has been described. However, the objects to be scheduled by the information processing device 120 are not limited to the ReduceScatter process and the Allgather process.

For example, substantially the same scheduling may be performed for processes substantially the same as the ReduceScatter process and the Allgather process. Here, the ReduceScatter process can be said to be a process in which for M pieces of data included in each of N nodes (unit of, for example, one accelerator or one server device), each of the nodes holds M/N results obtained by reducing the M pieces of data. Therefore, a process substantially the same as the ReduceScatter process includes a process in which the reducing method and the holding method are modified. Specifically, based on the following assumptions:
there are N nodes;
M pieces of data are included in each of the nodes;
computation and communication are performed cooperatively among N nodes to obtain M reduced results;
M reduced results are held in the N nodes; and
the correspondence between the M reduced results and the N nodes is arbitrary,
   the process may be, for example, a process in which with respect to M reduced results, among N nodes, N/2 nodes each hold 2M/N reduced results, and remaining N/2 nodes do not hold any reduced results.

### Fourth Embodiment

In the above-described embodiments, the case where each of the workers performs the backward calculation by dividing it into the backward data calculation and the backward weight calculation has been described. However, the scheduling method described in the above-described embodiments is also applicable to a case where the backward calculation is performed without dividing it into the backward data calculation and the backward weight calculation.

Additionally, in the above-described first embodiment, the example of FIG. 7 indicates the case where the backward calculation identifier is divided into the backward data calculation identifier and the backward weight calculation identifier, but the dividing method performed by the dividing unit 302 is not limited thereto. For example, the dividing unit 302 may divide a plurality of calculations included in the backward calculation into a first calculation identifier indicating a calculation to be executed before other calculations and a second calculation identifier indicating a calculation to be executed after the first calculation. Specifically, when the model to be trained is a Transformer, a backward weight calculation of a normalization process (Layer Normalization, RMS Normalization, or the like) may be classified as the backward data calculation. This is because the memory usage amount can be reduced by executing the backward weight calculation of the normalization process first.

Additionally, in the above-described embodiments, when assigning workers whose names are “Worker 0” to “Worker 3” to the layers of “NN0” to “NN3”, the assignment destinations are changed in the following cases:
the case of the training process using Micro-batches 0 to 3; and
the case of the training process using Micro-batches 4 to 7.
   However, in applying the scheduling method described in the above embodiments, it is not necessary to change the assignment destination between the case of the training process using Micro-batches 0 to 3 and the case of the training process using Micro-batches 4 to 7.

Additionally, in the above embodiments, the description assumes that the ReduceScatter process is performed successively every time the gradient information on which the ReduceScatter process can be performed is calculated. However, the object to be processed successively is not limited thereto, and a process after the ReduceScatter process may also be processed successively. For example, the information processing system 100 may be configured to perform communication between the workers every time a part of the ReduceScatter process is completed. With this, the start timing of performing the Allgather process can be advanced.

Additionally, in the above-described embodiments, the description assumes that the communication is performed between the worker whose name is “Worker 0” and the worker whose name is “Worker 3”. Additionally, the description assumes that the communication is performed between the worker whose name is “Worker 1” and the worker whose name is “Worker 2”. However, the combination of the workers to perform the communication is not limited thereto, and may be changed by pipeline parallel scheduling.

Additionally, in the above-described embodiments, the case where the number of workers to perform the communication is even has been described. With respect to the above, in the case where the number of workers to perform the communication is odd, the communication is performed by a combination of an even number of workers excluding one worker, and the scheduling may be performed such that the one worker is not combined with the other workers (that is, no communication is performed with the other workers).

Additionally, although the method of updating the optimizer state is not mentioned in detail in the above-mentioned embodiments, Adaptive moment estimation (Adam) may be used as the method of updating the optimizer state, for example. Alternatively, the optimizer state may be updated by a method other than Adam.

### Fifth Embodiment

In the above-mentioned embodiments, the scheduling when the training process is performed by combining data parallelism and pipeline parallelism has been described, but the application of the scheduling is not limited to the combination. For example, the scheduling may be applied to a case where the training process is performed by combining sequence parallelism and pipeline parallelism, or to a case where the training process is performed by combining data parallelism, sequence parallelism, and pipeline parallelism.

### Sixth Embodiment

In the above-mentioned embodiments, the case where the ReduceScatter process and the Allgather process are included in the training process has been described.

However, instead of the ReduceScatter process, an intermediate process between the ReduceScatter process and the Reduce process may be included. For example, in a case of the ReduceScatter process of size N (where N is an even number), N accelerators perform the communication and the calculation, and N equally divided results are held. In a case of the Reduce process of size N (where N is an even number), N accelerators perform the communication and the calculation, and only one accelerator holds the results. The intermediate process may be, for example, a process in which N accelerators perform the communication and the calculation, and N/2 equally divided results are held by N/2 accelerators, and the remaining N/2 accelerators do not hold the results.

Similarly, instead of the Allgather process, an intermediate process between the Allgather process and the Broadcast process may be included. The intermediate process herein may be, for example, a process in which N/2 accelerators transition from an initial state in which N/2 equally divided results are held by N/2 accelerators to a state in which all the results are held by N accelerators by communication.

### Seventh Embodiment

In the above-described embodiments, the description assumes that the Allgather process is performed on the updated weight parameters. However, in order to speed up the Allgather process, the Allgather process can be performed after compressing the updated weight parameters. When compressing the updated weight parameters, if the compression rate is increased, the accuracy of the weight parameter may deteriorate when decompression is performed. Therefore, instead of compressing the updated weight parameters, the Allgather process can be performed after compressing the differences between the updated weight parameters and the pre-update weight parameters.

Here, each accelerator to which the difference is distributed by the Allgather process retains the pre-update weight parameter, and even if the accuracy of the difference to be distributed is deteriorated, the accuracy of the result of adding the difference is not necessarily deteriorated. In other words, by performing the Allgather process after compressing the differences between the updated weight parameters and the pre-update weight parameters, deterioration of the weight parameter can be avoided even if the compression rate is increased. In the following, a seventh embodiment will be described focusing on the differences from the above embodiments.

### <General Allgather Process Flow>

First, a general Allgather process flow will be described. In distributed learning that at least partially adopts data parallelism, the following processes are performed in series or in parallel.
A plurality of nodes (accelerators) included in a worker execute forward calculations and backward calculations.
The ReduceScatter process of the gradient information is performed between the plurality of nodes. As a result, the gradient information is distributed and calculated.
The update process such as Adam is performed using the result of the ReduceScatter process and the optimizer state.
The Allgather process is performed on the result of the update process.

Additionally, before the Allgather process is performed, compression may be performed on the result of the update process by quantizing it to about four bits per element, for example. If the compression rate is increased, the amount of communication is reduced, so that the time required for the Allgather process is shortened, and as a result, the entire training process is speeded up.

### <Allgather Process Flow in Present Embodiment>

Here, it is noted that all nodes (accelerators) participating in the ReduceScatter process and the Allgather process hold the pre-update weight parameters. Specifically, the following points are noted.
Each of the nodes holds the weight parameters used for the forward calculation and the backward calculation.
The weight parameters are distributed before the first iteration.
In the second and subsequent iterations, the weight parameters are updated using the method of the above-described embodiments.
   Normally, because the update process does not change the value of the weight parameter greatly, the difference between the pre-update weight parameter and the updated weight parameter is small. Therefore, if the Allgather process is performed on the differences of low accuracy, and each of the nodes adds the difference, on which the Allgather process is performed, to the pre-update weight parameter, each of the nodes can maintain the accuracy of the updated weight parameters. That is, as a result, the Allgather process with high accuracy can be performed on the weight parameters compressed at a high compression rate.

As described, according to the seventh embodiment, the following effects are obtained.
By performing the Allgather process of the differences between the pre-update parameters and the updated parameters, the Allgather process of large data can be replaced with the Allgather process of small data.
The communication amount of the Allgather process can be reduced in the workers.
The training speed can be improved.

### <Details of Processing Procedure of Allgather Process in Present Embodiment>

Next, a processing procedure of the Allgather process in the seventh embodiment will be described in detail. In the seventh embodiment, the Allgather process is performed by the following processing procedure.

1) The rank 0 updates the weight parameter and the optimizer state by using the gradient information of the weight parameter of the neural network and the optimizer state. Here, the weight parameter may be included in the optimizer state.
The rank 0 has the optimizer state necessary for updating the weight parameter.
The updated weight parameter (high precision) is x.
The pre-update weight parameter (high precision) is x′.
The updated weight parameter (low precision) is x_lp.
The pre-update weight parameter (low precision) is x_lp′.
   2) The rank 0 calculates the difference d between the updated weight parameter and the pre-update weight parameter (d=x−x_lp′).
   3) The rank 0 compresses the difference and calculates the difference d′ after compression (d′=compress (d)).
   4) The rank 0 performs the Allgather process on the compressed difference (d′) and distributes it to the rank 1 to rank 3.
   5) Each of the rank 1 to rank 3 decompresses the compressed difference (d′) and obtains the difference (d″) (d″=decompress(d′)).
   6) Each of the rank 1 to rank 3 calculates the updated weight parameter (x_lp) by using the decompressed difference (d″) and the pre-update weight parameter (x_lp′) (x_lp=x_lp′+d″). Here, each of the rank 1 to rank 3 retain the pre-update weight parameter (x_lp′) until this step is performed.
   7) The process the same as the above is performed in parallel for the rank 1 to rank 3.

### <Specific Example of Compression>

Next, a specific example of compression equivalent to the above-described compress (d) will be described. For example, if x_lp and x_lp′ are 16 bits per element, d′=compress(d) converts each of the elements to an 8-bit floating point number (FP8). With this, 16-bit communication per element in the conventional method becomes 8-bit communication per element. Here, for example, instead of the compression, the low-rank approximation of the matrix used in PowerSGD and GaLore may be used.

### <Variation of Processing Procedure of Allgather Process in Present Embodiment>

In the above-described processing procedure, in 6), x_lp is calculated using only d″. However, d″ in the actual training process does not necessarily change greatly from iteration to iteration. Therefore, the previous d″ may be used. Additionally, the compression may be performed for d=x−x′. Additionally, instead of using the previous d″, the weight parameter of two iterations before may be used.

Additionally, in the above description, the Allgather process is performed after compressing the difference for all the updated weight parameters. However, for some weight parameters, the Allgather process may be performed on the difference without compressing the difference. Alternatively, for some weight parameters, the Allgather process may be performed on the weight parameter without calculating the difference.

For example, when the model to be trained is a large language model (LLM), weight parameters of a linear layer in a Transformer block are dominant, and therefore, there is a large merit of compressing the difference with respect to these weight parameters. For weight parameters other than the Transformer block and weight parameters related to normalization in the Transformer block, the merit of compressing the difference is not so large. Therefore, for some weight parameters, the Allgather process may be performed on the difference without compressing the difference. Alternatively, for some weight parameters, the Allgather process may be performed on the weight parameter without calculating the difference.

Additionally, the Allgather process in the present embodiment may be applied to the Allgather process in each of the above-described embodiments. In this case, the pre-update weight parameter is held by each of the ranks. Alternatively, the pre-update weight parameter may be obtained from another worker as necessary. When the Allgather process of the present embodiment is applied to the Allgather process in each of the above-described embodiments, the Allgather process may be applied to some weight parameter updates among the multiple weight parameter updates. Here, the compression of the present embodiment may be applied to a training process of a model using other embodiments, not limited to the above-described embodiments.

### Eighth Embodiment

The schedule of the training process illustrated in each of the above-described embodiments is an example, and it is needless to say that other schedules may be generated. For example, when the forward processing of the neural network is executed, a schedule in which forward processing by one or more other workers is executed between the forward processing by the first worker and the forward processing by the second worker may be generated.

Additionally, the configuration of the neural network illustrated in each of the above-described embodiments is an example, and other configurations may be used. For example, in the neural network, other parameters corresponding to other layers may be included before and after the first parameters corresponding to the first layer, or before and after the second parameters corresponding to the second layer.

Additionally, various variations are included in the training process schedule illustrated in each of the above-described embodiments.

For example, “A first worker executes forward processing for first data, using first parameters of a neural network” includes executing forward processing, using a result of another worker executing forward processing for first data.

For example, “To generate first gradient information of second parameters based on a third output and a fourth output” includes generating first gradient information of second parameters based on an output, from a final layer, generated using a third output and an output, from the final layer, generated using a fourth output.

Additionally, in the above-described embodiments, a predetermined worker performing a predetermined process includes, as a non-restrictive example, one or more accelerators among a plurality of accelerators included in the predetermined worker performing the predetermined process. Alternatively, a predetermined worker performing a predetermined process includes, as a non-restrictive example, the predetermined process being performed by a plurality of accelerators included in the predetermined worker performing different processes.

### Other Embodiments

In the above-described embodiments, when the schedule of the backward weight calculation after the backward data calculation in the training process is completed is generated, the schedule of the backward weight calculations of the layers 0 to 3 included in the NN is described. The layers 0 to 3 included in the NN are examples of layers included in a neural network, and in the case of a model other than the neural network, the schedule of the backward weight calculations is generated for each of layers included in the model.

Additionally, in the above-described embodiments, the schedule of replacing the assignment of workers to the layers (NN0 to NN3) of the neural network once has been described. However, the replacement of the assignment of workers is not limited to once, and the schedule may be generated so as to repeat the replacement. For example, in the above-described embodiments, the assignment of workers is replaced when Micro-batch 4 to Micro-batch 7 are input, but the assignment of workers may also be replaced when Micro-batch 8 to Micro-batch 11 are input. Specifically, the assignment may be restored to the assignment when Micro-batch 0 to Micro-batch 3 are input. That is, the schedule may be generated so as to replace the assignment alternately.

Additionally, in the above-described embodiments, a micro-batch has been described as an example as a processing unit (batch) of training data to be executed by each of the workers during the training process. However, the batch of training data is not limited to a micro-batch and may be a mini-batch. Additionally, one batch may be one of a plurality of divided training data or may include one or more data included in the training data.

Additionally, in the above-described embodiments, the description assumes that when each of the workers executes the backward calculation, the backward calculation is divided into the backward data calculation and the backward weight calculation and executed. However, in the scheduling of one worker (for example, the worker whose name is “Worker 0”), the backward calculation does not need to be divided into the backward data calculation and the backward weight calculation and may be scheduled as one unit of calculation.

Additionally, in the above-described embodiments, the case where the information processing device 120 applies the scheduling method to the training process has been described, but the information processing device 120 may apply the scheduling method to a process other than the training process. That is, the information processing device 120 may apply the scheduling method to data other than the training data.

Additionally, in the above-described embodiments, the case where the information processing device 120 is provided separately from the server device group 110 has been described. However, the information processing device 120 may be integrated with the server device group 110.

Specifically, all functions of the information processing device 120 may be implemented in a part of the server device group 110. That is, the information processing system 100 may include the server device group 110 including N devices and one information processing device 120, or the server device group 110 including (N−1) devices and one server device. Alternatively, the information processing device 120 itself may be a worker or a part of a worker.

Additionally, in the above-described embodiments, although in the information processing system 100, the information processing device 120 has been described as including one device, the information processing device 120 may include a plurality of devices.

In the present specification (including the claims), if the expression “at least one of a, b, and c” or “at least one of a, b, or c” is used (including similar expressions), any one of a, b, c, a-b, a-c, b-c, or a-b-c is included. Multiple instances may also be included in any of the elements, such as a-a, a-b-b, and a-a-b-b-c-c. Further, the addition of another element other than the listed elements (i.e., a, b, and c), such as adding d as a-b-c-d, is included.

In the present specification (including the claims), if the expression such as “in response to data being input”, “based on data”, “according to data”, or “in accordance with data” (including similar expressions) is used, unless otherwise noted, a case in which various data itself is used as an input and a case in which data obtained by processing various data (e.g., data obtained by adding noise, normalized data, and intermediate representation of various data) is used as an input are included. If it is described that any result can be obtained “based on data”, “according to data”, or “in accordance with data”, a case in which the result is obtained based on only the data is included, and a case in which the result is obtained affected by another data other than the data, factors, conditions, and/or states may be included. If it is described that “data is output”, unless otherwise noted, a case in which various data itself is used as an output is included, and a case in which data obtained by processing the data in some way (e.g., data obtained by adding noise, normalized data, and intermediate representation of the data) is used as an output is included.

In the present specification (including the claims), if the terms “connected” and “coupled” are used, the terms are intended as non-limiting terms that include any of direct, indirect, electrically, communicatively, operatively, and physically connected/coupled. Such terms should be interpreted according to a context in which the terms are used, but a connected/coupled form that is not intentionally or naturally excluded should be interpreted as being included in the terms without being limited.

In the present specification (including the claims), if the expression “A configured to B” is used, a case in which a physical structure of the element A has a configuration that can perform the operation B, and a permanent or temporary setting/configuration of the element A is configured/set to actually perform the operation B may be included. For example, if the element A is a general purpose processor, the processor may have a hardware configuration that can perform the operation B and be configured to actually perform the operation B by setting a permanent or temporary program (i.e., an instruction). If the element A is a dedicated processor, a dedicated arithmetic circuit, or the like, a circuit structure of the processor may be implemented so as to actually perform the operation B irrespective of whether the control instruction and the data are actually attached.

In the present specification (including the claims), if a term indicating inclusion or possession (e.g., “comprising”, “including”, or “having”) is used, the term is intended as an open-ended term, including inclusion or possession of an object other than a target object indicated by the object of the term. If the object of the term indicating inclusion or possession is an expression that does not specify a quantity or that suggests a singular number (i.e., an expression using “a” or “an” as an article), the expression should be interpreted as being not limited to a specified number.

In the present specification (including the claims), even if an expression such as “one or more” or “at least one” is used in a certain description, and an expression that does not specify a quantity or that suggests a singular number (i.e., an expression using “a” or “an” as an article) is used in another description, it is not intended that the latter expression indicates “one”. Generally, an expression that does not specify a quantity or that suggests a singular number (i.e., an expression using “a” or “an” as an article) should be interpreted as being not necessarily limited to a particular number.

In the present specification, if it is described that a particular advantage/result is obtained in a particular configuration included in an embodiment, unless there is a particular reason, it should be understood that that the advantage/result may be obtained in another embodiment or other embodiments including the configuration. It should be understood, however, that the presence or absence of the advantage/result generally depends on various factors, conditions, states, and/or the like, and that the advantage/result is not necessarily obtained by the configuration. advantage/result is merely an advantage/result that is obtained by the configuration described in the embodiment when various factors, conditions, and/or states are satisfied, and is not necessarily obtained in the invention according to the claim that defines the configuration or a similar configuration.

In the present specification (including the claims), if multiple hardware performs predetermined processes, each of the hardware may cooperate to perform the predetermined processes, or some of the hardware may perform all of the predetermined processes. Additionally, some of the hardware may perform some of the predetermined processes while other hardware may perform the remainder of the predetermined processes. In the present specification (including the claims), if an expression such as “one or more hardware perform a first process and the one or more hardware perform a second process” is used, the hardware that performs the first process may be the same as or different from the hardware that performs the second process. That is, the hardware that performs the first process and the hardware that performs the second process may be included in the one or more hardware. The hardware may include an electronic circuit, a device including an electronic circuit, or the like.

In the present specification (including the claims), if multiple storage devices (memories) store data, each of the multiple storage devices (memories) may store only a portion of the data or may store an entirety of the data.

Although the embodiments of the present disclosure have been described in detail above, the present disclosure is not limited to the individual embodiments described above. Various additions, modifications, substitutions, partial deletions, and the like can be made without departing from the conceptual idea and spirit of the invention derived from the contents defined in the claims and the equivalents thereof. For example, in all the embodiments described above, the numerical values used in the description are described as examples and the embodiments are not limited thereto. Additionally, the order of the operations in the embodiments is described as an example and the embodiments are not limited thereto.

Here, in the disclosed technique, the following appended forms can be considered.

### (Clause 1)

An information processing system configured to perform a training process of a neural network by using one or more first workers and one or more second workers,
wherein the one or more first workers are configured to:
   perform forward processing on first data by using first parameters of the neural network to generate a first output; and
   perform forward processing on second data by using the first parameters to generate a second output,
wherein the one or more second workers are configured to:
   perform forward processing based on the first output by using second parameters of the neural network to generate a third output;
   perform forward processing based on the second output by using the second parameters to generate a fourth output;
   generate first gradient information of the second parameters based on the third output and the fourth output;
   perform a first process on the first gradient information;
   update the second parameters based on a result of performing the first process; and
   transmit the updated second parameters to the one or more first workers, and
wherein the one or more first workers are further configured to perform a second process by using the updated second parameters received from the one or more second workers.

### (Clause 2)

An information processing system configured to perform a training process of a neural network by using one or more first workers and one or more second workers,
wherein the one or more first workers are configured to:
   perform forward processing on first data by using first parameters of the neural network to generate a first output; and
   perform forward processing on second data by using the first parameters to generate a second output,
wherein the one or more second workers are configured to:
   perform forward processing based on the first output by using second parameters of the neural network to generate a third output;
   perform forward processing based on the second output by using the second parameters to generate a fourth output;
   generate first gradient information of the second parameters based on the third output and the fourth output;
   perform a first process on the first gradient information; and
   transmit a result of performing the first process to the one or more first workers, and
wherein the one or more first workers are further configured to:
   update the first parameters by using the result received from the one or more second workers; and
   perform a second process by using the updated first parameter.

### (Clause 3)

The information processing system as described in Clause 1 or 2, wherein the first process is a process of collecting elements of the first gradient information in the one or more second workers.

### (Clause 4)

The information processing system as described in Clause 1 or 2, wherein the first process is a ReduceScatter process of the first gradient information in the one or more second workers.

### (Clause 5)

The information processing system as described in Clause 1 or 2, wherein the first process is a process of reducing elements of data included in the first gradient information among nodes included in the one or more second workers, and storing a result of the reducing in each of the nodes included in the one or more second workers, a number of the elements of the data being determined in advance for each of the nodes.

### (Clause 6)

The information processing system as described in Clause 1, wherein the second process is a process of distributing the updated second parameters in the one or more first workers.

### (Clause 7)

The information processing system as described in Clause 1, wherein the second process is an Allgather process of the updated second parameters in the one or more first workers.

### (Clause 8)

The information processing system as claimed in Clause 2, wherein the second process is a process of distributing the updated first parameters in the one or more first processors.

### (Clause 9)

The information processing system as claimed in Clause 2, wherein the second process is an Allgather process of the updated first parameters in the one or more first workers.

### (Clause 10)

The information processing system as described in Clause 1,
wherein the one or more second workers are further configured to:
   perform the forward processing on third data by using the updated first parameters of the neural network to generate a fifth output; and
   perform the forward processing on fourth data by using the updated first parameters to generate a sixth output,
wherein the one or more first workers are further configured to:
   perform the forward processing based on the fifth output by using the updated second parameters of the neural network to generate a seventh output;
   perform the forward processing based on the sixth output by using the updated second parameters to generate an eighth output;
   generate second gradient information of the updated second parameters based on the seventh output and the eighth output;
   perform the first process on the second gradient information; and
   transmit a result of performing the first process to the one or more second workers, and
wherein the one or more second workers are further configured to:
   further update the updated second parameters by using the result received from the one or more first workers; and
   perform the second process by using the further updated second parameters.

### (Clause 11)

The information processing system as described in Clause 2,
wherein the one or more second workers are further configured to:
   perform the forward processing on third data by using the updated first parameters of the neural network to generate a fifth output; and
   perform the forward processing on fourth data by using the updated first parameters to generate a sixth output,
wherein the one or more first workers are further configured to:
   perform the forward processing based on the fifth output by using the updated second parameters of the neural network to generate a seventh output;
   perform the forward processing based on the sixth output by using the updated second parameters to generate an eighth output;
   generate second gradient information of the updated second parameters based on the seventh output and the eighth output;
   perform the first process on the second gradient information;
   further update the updated second parameters by using a result of performing the first process; and
   transmit the further updated second parameters to the one or more second workers, and
wherein the one or more second workers are further configured to perform the second process by using the further updated second parameters received from the one or more first workers.

### (Clause 12)

The information processing system as described in Clause 1 or 2, wherein the one or more second workers performs the first process on a portion of the first gradient information before a backward calculation based on the third output and the fourth output in the one or more second workers are completed.

### (Clause 13)

The information processing system as described in Clause 1, wherein the one or more second workers updates a portion of the second parameters based on a result of performing the first process on a portion of the first gradient information before a backward calculation based on the third output and the fourth output in the one or more second workers are completed, and transmits the updated portion of the second parameters to the one or more first workers.

### (Clause 14)

The information processing system as described in Clause 2, wherein the one or more second workers transmits a result of performing the first process on a portion of the first gradient information to the one or more first workers before a backward calculation based on the third output and the fourth output in the one or more second workers are completed.

### (Clause 15)

The information processing system as described in Clause 1, wherein the one or more first workers performs the second process by using difference information between the second parameters and the updated second parameters.

### (Clause 16)

The information processing system as described in Clause 15, wherein the one or more first workers generates the difference information by compressing differences between the second parameters and the updated second parameters.

### (Clause 17)

The information processing system as described in Clause 16, wherein the one or more first workers calculates the updated second parameters by using the difference information after performing the second process and the pre-update second parameter.

### (Clause 18)

The information processing system as described in Clause 16, wherein the second process is a process of distributing the difference information in the one or more first workers.

### (Clause 19)

An information processing device configured to schedule to perform a training process of a neural network by using one or more first workers and one or more second workers,
wherein the one or more first workers are configured to:
   perform forward processing on first data by using first parameters of the neural network to generate a first output; and
   perform forward processing on second data by using the first parameters to generate a second output,
wherein the one or more second workers are configured to:
   perform forward processing based on the first output by using second parameters of the neural network to generate a third output;
   perform forward processing based on the second output by using the second parameters to generate a fourth output;
   generate gradient information of the second parameters based on the third output and the fourth output;
   perform a first process on the gradient information;
   update the second parameters based on a result of performing the first process; and
   transmit the updated second parameters to the one or more first workers, and
wherein the one or more first workers are further configured to perform a second process by using the updated second parameters received from the one or more second workers.

### (Clause 20)

An information processing device configured to schedule to perform a training process of a neural network by using one or more first workers and one or more second workers,
wherein the one or more first workers are configured to:
   perform forward processing on first data by using first parameters of the neural network to generate a first output; and
   perform forward processing on second data by using the first parameters to generate a second output,
wherein the one or more second workers are configured to:
   perform forward processing based on the first output by using second parameters of the neural network to generate a third output;
   perform forward processing based on the second output by using the second parameters to generate a fourth output;
   generate gradient information of the second parameters based on the third output and the fourth output;
   perform a first process on the gradient information; and
   transmit a result of performing the first process to the one or more first workers, and
wherein the one or more first workers are further configured to:
   update the first parameters by using the result received from the one or more second workers; and
   perform a second process by using the updated first parameter.

### (Clause 21)

An information processing method of performing a training process of a neural network by using one or more first workers and one or more second workers, the information processing method including:
performing, by the one or more first workers, forward processing on first data by using first parameters of the neural network to generate a first output;
performing, by the one or more first workers, forward processing on second data by using the first parameters to generate a second output,
performing, by the one or more second workers, forward processing based on the first output by using second parameters of the neural network to generate a third output;
performing, by the one or more second workers, forward processing based on the second output by using the second parameters to generate a fourth output;
generating, by the one or more second workers, gradient information of the second parameters based on the third output and the fourth output;
performing, by the one or more second workers, a first process on the gradient information;
updating, by the one or more second workers, the second parameters based on a result of performing the first process;
transmitting, by the one or more second workers, the updated second parameters to the one or more first workers, and
performing, by the one or more first workers, a second process by using the updated second parameters received from the one or more second workers.

### (Clause 22)

An information processing method of performing a training process of a neural network by using one or more first workers and one or more second workers, the scheduling method including:
performing, by the one or more first workers, forward processing on first data by using first parameters of the neural network to generate a first output;
performing, by the one or more first workers, forward processing on second data by using the first parameters to generate a second output;
performing, by the one or more second workers, forward processing based on the first output by using second parameters of the neural network to generate a third output;
performing, by the one or more second workers, forward processing based on the second output by using the second parameters to generate a fourth output;
generating, by the one or more second workers, gradient information of the second parameters based on the third output and the fourth output;
performing, by the one or more second workers, a first process on the gradient information;
transmitting, by the one or more second workers, a result of performing the first process to the one or more first workers;
updating, by the one or more first workers, the first parameters by using the result received from the one or more second workers; and
performing, by the one or more first workers, a second process by using the updated first parameter.

### (Clause 23)

A scheduling method of scheduling to perform a training process of a neural network by using one or more first workers and one or more second workers, the information processing method including scheduling, by a processor, processes including:
performing, by the one or more first workers, forward processing on first data by using first parameters of the neural network to generate a first output;
performing, by the one or more first workers, forward processing on second data by using the first parameters to generate a second output;
performing, by the one or more second workers, forward processing based on the first output by using second parameters of the neural network to generate a third output;
performing, by the one or more second workers, forward processing based on the second output by using the second parameters to generate a fourth output;
generating, by the one or more second workers, gradient information of the second parameters based on the third output and the fourth output;
performing, by the one or more second workers, a first process on the gradient information;
updating, by the one or more second workers, the second parameters based on a result of performing the first process;
transmitting, by the one or more second workers, the updated second parameters to the one or more first workers; and
performing, by the one or more first workers, a second process by using the updated second parameters received from the one or more second workers.

### (Clause 24)

A scheduling method of scheduling to perform a training process of a neural network by using one or more first workers and one or more second workers, the scheduling method including scheduling, by a processor, processes including:
performing, by the one or more first workers, forward processing on first data by using first parameters of the neural network to generate a first output;
performing, by the one or more first workers, forward processing on second data by using the first parameters to generate a second output;
performing, by the one or more second workers, forward processing based on the first output by using second parameters of the neural network to generate a third output;
performing, by the one or more second workers, forward processing based on the second output by using the second parameters to generate a fourth output;
generating, by the one or more second workers, gradient information of the second parameters based on the third output and the fourth output;
performing, by the one or more second workers, a first process on the gradient information;
transmitting, by the one or more second workers, a result of performing the first process to the one or more first workers;
updating, by the one or more first workers, the first parameters by using the result received from the one or more second workers; and
performing, by the one or more first workers, a second process by using the updated first parameter.

### (Clause 25)

A scheduling program causing a processor of an information processing device configured to schedule to perform a training process of a neural network by using one or more first workers and one or more second workers to schedule processes including:
performing, by the one or more first workers, forward processing on first data by using first parameters of the neural network to generate a first output;
performing, by the one or more first workers, forward processing on second data by using the first parameters to generate a second output;
performing, by the one or more second workers, forward processing based on the first output by using second parameters of the neural network to generate a third output;
performing, by the one or more second workers, forward processing based on the second output by using the second parameters to generate a fourth output;
generating, by the one or more second workers, gradient information of the second parameters based on the third output and the fourth output;
performing, by the one or more second workers, a first process on the gradient information;
updating, by the one or more second workers, the second parameters based on a result of performing the first process;
transmitting, by the one or more second workers, the updated second parameters to the one or more first workers; and performing, by the one or more first workers, a
second process by using the updated second parameters received from the one or more second workers.

### (Clause 26)

A scheduling program causing a processor of an information processing device configured to schedule to perform a training process of a neural network by using one or more first workers and one or more second workers to schedule processes including:
performing, by the one or more first workers, forward processing on first data by using first parameters of the neural network to generate a first output;
performing, by the one or more first workers, forward processing on second data by using the first parameters to generate a second output;
performing, by the one or more second workers, forward processing based on the first output by using second parameters of the neural network to generate a third output;
performing, by the one or more second workers, forward processing based on the second output by using the second parameters to generate a fourth output;
generating, by the one or more second workers, gradient information of the second parameters based on the third output and the fourth output;
performing, by the one or more second workers, a first process on the gradient information;
transmitting, by the one or more second workers, a result of performing the first process to the one or more first workers;
updating, by the one or more first workers, the first parameters by using the result received from the one or more second workers; and
performing, by the one or more first workers, a second process by using the updated first parameter.

What is claimed is:

1. An information processing system comprising one or more first processors and one or more second processors configured to perform a training process of a neural network,
wherein the one or more first processors are configured to:
perform forward processing on first data by using first parameters of the neural network to generate a first output; and
perform forward processing on second data by using the first parameters to generate a second output,
wherein the one or more second processors are configured to:
perform forward processing based on the first output by using second parameters of the neural network to generate a third output;
perform forward processing based on the second output by using the second parameters to generate a fourth output;
generate first gradient information of the second parameters based on the third output and the fourth output;
perform a first process on the first gradient information;
update the second parameters based on a result of performing the first process; and
transmit the updated second parameters to the one or more first processors, and
wherein the one or more first processors are further configured to perform a second process by using the updated second parameters received from the one or more second processors.

2. An information processing system comprising one or more first processors and one or more second processors configured to perform a training process of a neural network,
wherein the one or more first processors are configured to:
perform forward processing on first data by using first parameters of the neural network to generate a first output; and
perform forward processing on second data by using the first parameters to generate a second output,
wherein the one or more second processors are configured to:
perform forward processing based on the first output by using second parameters of the neural network to generate a third output;
perform forward processing based on the second output by using the second parameters to generate a fourth output;
generate first gradient information of the second parameters based on the third output and the fourth output;
perform a first process on the first gradient information; and
transmit a result of performing the first process to the one or more first processors, and
wherein the one or more first processors are further configured to:
update the second parameters by using the result received from the one or more second processors; and
perform a second process by using the updated second parameters.

3. The information processing system as claimed in claim 1, wherein the first process is a process of collecting elements of the first gradient information in the one or more second processors.

4. The information processing system as claimed in claim 2, wherein the first process is a process of collecting elements of the first gradient information in the one or more second processors.

5. The information processing system as claimed in claim 1, wherein the first process is a process of reducing elements of data included in the first gradient information among nodes included in the one or more second processors, and storing a result of the reducing in each of the nodes included in the one or more second processors.

6. The information processing system as claimed in claim 2, wherein the first process is a process of reducing elements of data included in the first gradient information among nodes included in the one or more second processors, and storing a result of the reducing in each of the nodes included in the one or more second processors.

7. The information processing system as claimed in claim 1, wherein the second process is a process of distributing the updated second parameters in the one or more first processors.

8. The information processing system as claimed in claim 2, wherein the second process is a process of distributing the updated second parameters in the one or more first processors.

9. The information processing system as claimed in claim 1,
wherein the one or more second processors are further configured to:
perform forward processing on third data by using updated first parameters of the neural network to generate a fifth output; and
perform forward processing on fourth data by using the updated first parameters to generate a sixth output,
wherein the one or more first processors are further configured to:
perform forward processing based on the fifth output by using the updated second parameters of the neural network to generate a seventh output;
perform forward processing based on the sixth output by using the updated second parameters to generate an eighth output;
generate second gradient information of the updated second parameters based on the seventh output and the eighth output;
perform a first process on the second gradient information; and
transmit a result of performing the first process to the one or more second processors,
wherein the one or more second processors are further configured to:
further update the updated second parameters by using the result received from the one or more first processors; and
perform a second process by using the further updated second parameters.

10. The information processing system as claimed in claim 2,
wherein the one or more second processors are further configured to:
perform forward processing on third data by using updated first parameters of the neural network to generate a fifth output; and
perform forward processing on fourth data by using the updated first parameters to generate a sixth output,
wherein the one or more first processors are further configured to:
perform forward processing based on the fifth output by using the updated second parameters of the neural network to generate a seventh output;
perform forward processing based on the sixth output by using the updated second parameters to generate an eighth output;
generate second gradient information of the updated second parameters based on the seventh output and the eighth output;
perform a first process on the second gradient information;
further update the updated second parameters by using a result of performing the first process; and
transmit the further updated second parameters to the one or more second processors,
wherein the one or more second processors are further configured to perform a second process by using the further updated second parameters.

11. The information processing system as claimed in claim 1, wherein the one or more second processors perform the first process on a portion of the first gradient information before a backward calculation based on the third output and the fourth output in the one or more second processors is completed.

12. The information processing system as claimed in claim 2, wherein the one or more second processors perform the first process on a portion of the first gradient information before a backward calculation based on the third output and the fourth output in the one or more second processors is completed.

13. The information processing system as claimed in claim 1, wherein the one or more second processors update a portion of the second parameters based on a result of performing the first process on a portion of the first gradient information before a backward calculation based on the third output and the fourth output in the one or more second processors is completed, and transmit the updated portion of the second parameters to the one or more first processors.

14. The information processing system as claimed in claim 2, wherein the one or more second processors transmit a result of performing the first process on a portion of the first gradient information to the one or more first processors before a backward calculation based on the third output and the fourth output in the one or more second processors is completed.

15. The information processing system as claimed in claim 1, wherein the one or more first processors perform the second process by using difference information between the second parameters and the updated second parameters.

16. The information processing system as claimed in claim 15, wherein the one or more first processors generate the difference information by compressing differences between the second parameters and the updated second parameters.

17. The information processing system as claimed in claim 15, wherein the one or more first processors calculate the updated second parameters by using the difference information after performing the second process and the second parameters.

18. The information processing system as claimed in claim 15, wherein the second process is a process of distributing the difference information in the one or more first processors.

19. An information processing method of performing a training process of a neural network by using one or more first processors and one or more second processors, the information processing method comprising:
performing, by the one or more first processors, forward processing on first data by using first parameters of the neural network to generate a first output;
performing, by the one or more first processors, forward processing on second data by using the first parameters to generate a second output;
performing, by the one or more second processors, forward processing based on the first output by using second parameters of the neural network to generate a third output;
performing, by the one or more second processors, forward processing based on the second output by using the second parameters to generate a fourth output;
generating, by the one or more second processors, gradient information of the second parameters based on the third output and the fourth output;
performing, by the one or more second processors, a first process on the gradient information;
updating, by the one or more first processors or by the one or more second processors, the second parameters based on a result of performing the first process; and
performing, by the one or more first processors, a second process by using the updated second parameters.

20. A non-transitory computer-readable recording medium having stored therein a program for causing an information processing system including one or more first processors and one or more second processors to perform a training process of a neural network, the training process comprising:
performing, by the one or more first processors, forward processing on first data by using first parameters of the neural network to generate a first output;
performing, by the one or more first processors, forward processing on second data by using the first parameters to generate a second output,
performing, by the one or more second processors, forward processing based on the first output by using second parameters of the neural network to generate a third output;
performing, by the one or more second processors, forward processing based on the second output by using the second parameters to generate a fourth output;
generating, by the one or more second processors, first gradient information of the second parameters based on the third output and the fourth output;
performing, by the one or more second processors, a first process on the first gradient information;
updating, by the one or more first processors or by the one or more second processors, the second parameters based on a result of performing the first process; and
performing, by the one or more first processors, a second process by using the updated second parameters.
